(19) United States
(12) Patent Application Publication
(10) Pub. No.: US 2012/0198152 A1
(43) Pub. Date: Aug. 2, 2012

(54) SYSTEM, APPARATUS, AND METHOD SUPPORTING ASYMMETRICAL BLOCK-LEVEL REDUNDANT STORAGE

(75) Inventors: Julian Michael Terry, Los Gatos, CA (US); Rodney G. Harrison, Seattle, WA (US)

(73) Assignee: DROBO, INC., San Jose, CA (US)

(21) Appl. No.: 13/363,740

(22) Filed: Feb. 1, 2012

Related U.S. Application Data
(60) Provisional application No. 61/547,953, filed on Oct. 17, 2011.
(60) Provisional application No. 61/440,081, filed on Feb. 7, 2011.
(60) Provisional application No. 61/438,556, filed on Feb. 1, 2011.

(51) Int. Cl. G06F 12/00

(52) U.S. Cl. 711/114; 711/E12.001

(57) ABSTRACT

A block-level storage system and method support asymmetrical block-level redundant storage by automatically determining performance characteristics associated with at least one region of each of a number of block storage devices and creating a plurality of redundancy zones from regions of the block storage devices, where at least one of the redundancy zones is a hybrid zone including at least two regions having different but complementary performance characteristics selected from different block storage devices based on a predetermined performance level selected for the zone. Such “hybrid” zones can be used in the context of block-level tiered redundant storage, in which zones may be intentionally created for a predetermined tiered storage policy from regions on different types of block storage devices or regions on similar types of block storage devices but having different but complementary performance characteristics.

### CROSS-REFERENCE TO RELATED APPLICATION(S)

This application claims the benefit of the following U.S. Provisional Patent Applications: U.S. Provisional Patent Application No. 61/547,953 filed on Oct. 17, 2011, which is a follow-on to U.S. Provisional Patent Application No. 61/440,081 filed on Feb. 7, 2011, which in turn is a follow-on to U.S. Provisional Patent Application No. 61/438,556, filed on Feb. 1, 2011; each of these provisional patent applications is hereby incorporated herein by reference in its entirety.

### FIELD OF THE INVENTION

The present invention relates generally to data storage systems and more specifically to block-level data storage systems that store data redundantly using a heterogeneous mix of storage media.

### BACKGROUND OF THE INVENTION

RAID (Redundant Array of Independent Disks) is a well-known data storage technology in which data is stored redundantly across multiple storage devices, e.g., mirrored across two storage devices or striped across three or more storage devices.

While RAID is used in many storage systems, a similar type of redundant storage is provided by a device known as the Drobo™ storage product sold by Drobo, Inc. of Santa Clara, Calif. Generally speaking, the Drobo™ storage product automatically manages redundant data storage according to a mixture of redundancy schemes, including automatically reconfiguring redundant storage patterns in a number of storage devices (typically hard disk drives such as SATA disk drives) based on, among other things, the amount of storage space available at any given time and the existing storage patterns. For example, a unit of data initially might be stored in a mirrored pattern and later converted to a striped pattern, e.g., if an additional storage device is added to the storage system or in to free up some storage space (since striping generally consumes less overall storage than mirroring). Similarly, a unit of data might be converted from a striped pattern to a mirrored pattern, e.g., if a storage device fails or is removed from the storage system. The Drobo™ storage product generally attempts to maintain redundant storage of all data at all times given the storage devices that are installed, including even storing a unit of data mirrored on a single storage device if redundancy cannot be provided across multiple storage devices. Some of the functionality provided by the Drobo™ storage product is described generally in U.S. Pat. No. 7,814,273 entitled Dynamically Expandable and Contractible Fault-Tolerant Storage System Permitting Variously Sized Storage Devices, issued Oct. 12, 2010, which is incorporated herein by reference in its entirety.

As with many RAID systems and other types of storage systems, the Drobo™ storage product includes a number of storage device slots that are treated collectively as an array. Each storage device slot is configured to receive a storage device, e.g., a SATA drive. Typically, the array is populated with at least two storage devices and often more, although the number of storage devices in the array can change at any given time as devices are added, removed, or fail. The Drobo™ storage product automatically detects when such events occur and automatically reconfigures storage patterns as needed to maintain redundancy according to a predetermined set of storage policies.

### SUMMARY OF EXEMPLARY EMBODIMENTS

A block-level storage system and method support asymmetrical block-level redundant storage by automatically determining performance characteristics associated with at least one region of each of a number of block storage devices and creating a plurality of redundancy zones from regions of the block storage devices, where at least one of the redundancy zones is a hybrid zone including at least two regions having different but complementary performance characteristics selected from different block storage devices based on a predetermined performance level selected for the zone. Such “hybrid” zones can be used in the context of block-level tiered redundant storage, in which zones may be intentionally created for a predetermined tiered storage policy from regions on different types of block storage devices or regions on similar types of block storage devices but having different but complementary performance characteristics. The types of storage tiers to have in the block-level storage system may be determined automatically, and one or more zones are automatically generated for each of the tiers, where the predetermined storage policy selected for a given zone is based on the determination of the types of storage tiers.

Embodiments include a method of managing storage of blocks of data from a host computer in a block-level storage system having a storage controller in communication with a plurality of block storage devices. The method involves automatically determining, by the storage controller, performance characteristics associated with at least one region of each block storage device; and creating a plurality of redundancy zones from regions of the block storage devices, where at least one of the redundancy zones is a hybrid zone including at least two regions having different but complementary performance characteristics selected by the storage controller from different block storage devices based on a predetermined performance level selected for the zone by the storage controller.

Embodiments also include a block-level storage system comprising a storage controller for managing storage of blocks of data from a host computer and a plurality of block storage devices in communication with the storage controller, wherein the storage controller, wherein the storage controller is configured to automatically determine performance characteristics associated with at least one region of each block storage device and to create a plurality of redundancy zones from regions of the block storage devices, where at least one of the redundancy zones is a hybrid zone including at least two regions having different but complementary performance characteristics selected by the storage controller from different block storage devices based on a predetermined performance level selected for the zone by the storage controller.

The at least two regions may be selected from regions having similar complementary performance characteristics or from regions having dissimilar complementary performance characteristics (e.g., regions may be selected from at least one solid state storage drive and from at least one disk storage device). Performance characteristics of a block storage device may be based on such things as the type of block storage device, operating parameters of the block storage device, and/or empirically tested performance of the block storage device. The performance of a block storage device may be tested upon installation of the block storage device into the block-level storage system and/or at various times during operation of the block-level storage system.

Regions may be selected from the same types of block storage devices, wherein such block storage devices may include a plurality of regions having different relative performance characteristics, and at least one region may be selected based on such relative performance characteristics. A particular selected block storage device may be configured so that at least one region of such block storage device selected for the hybrid zone has performance characteristics that are complementary to at least one region of another block storage device selected for the hybrid zone. The redundancy zones may be associated with a plurality of block-level storage tiers, in which case the types of storage tiers to have in the block-level storage system may be automatically determined, and one or more zones may be automatically generated for each of the tiers, wherein the predetermined storage policy selected for a given zone by the storage controller may be based on the determination of the types of storage tiers. The types of storage tiers may be determined based on such things as the types of host accesses to a particular block or blocks, the frequency of host accesses to a particular block or blocks, and/or the type of data contained within a particular block or blocks.

In further embodiments, a change in performance characteristics of a block storage device may be detected, in which case at least one redundancy zone in the block-level storage system may be reconfigured based on the changed performance characteristics. Such reconfiguring may involve, for example, adding a new storage tier to the storage system, removing an existing storage tier from the storage system, moving a region of the block storage device from one redundancy zone to another redundancy zone, or creating a new redundancy zone using a region of storage from the block storage device. Each of the redundancy zones may be configured to store data using a predetermined redundant data layout selected from a plurality of redundant data layouts, in which case at least two of the zones may have different redundant data layouts.

Additional embodiments may be disclosed and claimed.

### BRIEF DESCRIPTION OF THE DRAWINGS

The foregoing features of embodiments will be more readily understood by reference to the following detailed description, taken with reference to the accompanying drawings, in which:

FIG. 1 is a flowchart showing a method of operating a data storage system in accordance with an exemplary embodiment of transaction aware data tiering;

FIG. 2 schematically shows hybrid redundancy zones created from a mixture of block storage device types, in accordance with an exemplary embodiment;

FIG. 3 schematically shows hybrid redundancy zones created from a mixture of block storage device types, in accordance with an exemplary embodiment;

FIG. 4 schematically shows redundancy zones creates from regions of the same types and configurations of HDDs, in accordance with an exemplary embodiment;

FIG. 5 schematically shows logic for managing block-level tiering when a block storage device is added to the storage system, in accordance with an exemplary embodiment;

FIG. 6 schematically shows logic for managing block-level tiering when a block storage device is removed from the storage system, in accordance with an exemplary embodiment;

FIG. 7 schematically shows logic for managing block-level tiering based on changes in performance characteristics of a block storage device over time, in accordance with an exemplary embodiment;

FIG. 8 schematically shows a logic flow for such block-level tiering, in accordance with an exemplary embodiment;

FIG. 9 schematically shows a block-level storage system (BLSS) used for a particular host filesystem storage tier (in this case, the host filesystem's tier 1 storage), in accordance with an exemplary embodiment;

FIG. 10 schematically shows an exemplary half-stripe-mirror (HSM) configuration in which the data is RAID-0 striped across multiple disk drives (three, in this example) with mirroring of the data on the SSD, in accordance with an exemplary embodiment;

FIG. 11 schematically shows an exemplary re-layout upon failure of the SSD in FIG. 10;

FIG. 12 schematically shows an exemplary re-layout upon failure of one of the mechanical drives in FIG. 10;

FIG. 13 schematically shows the use of a single SSD in combination with a mirrored stripe configuration, in accordance with an exemplary embodiment;

FIG. 14 schematically shows the use of a single SSD in combination with a striped mirror configuration, in accordance with an exemplary embodiment;

FIG. 15 schematically shows a system having both SSD and non-SSD half-stripe-mirror zones, in accordance with an exemplary embodiment; and

FIG. 16 is schematic block diagram showing relevant components of a computing environment in accordance with an exemplary embodiment of the invention.

### DETAILED DESCRIPTION OF SPECIFIC EMBODIMENTS

Embodiments of the present invention include data storage systems (e.g., a Drobo™ type storage device or other storage array device, often referred to as an embedded storage array or ESA) supporting multiple storage devices (e.g., hard disk drives or HDDs, solid state drives or SSDs, etc.) and implementing one or more of the storage features described below. Such data storage systems may be populated with all the same type of block storage device (e.g., all HDDs or all SSDs) or may be populated with a mixture of different types of block storage devices (e.g., different types of HDDs, one or more HDDs and one or more SSDs, etc.).

SSD devices are now being sold in the same form-factors as regular disk drives (e.g., in the same form-factor as a SATA drive) and therefore such SSD devices generally may be installed in a Drobo™ storage product or other type of storage array. Thus, for example, an array might include all disk drives, all SSD devices, or a mix of disk and SSD devices, and the composition of the array might change over time, e.g., beginning with all disk drives, then adding one SSD drive, then adding a second SSD drive, then replacing a disk drive with an SSD drive, etc. Generally speaking, SSD devices have faster access times than disk drives, although they generally have lower storage capacities than disk drives for a given cost.

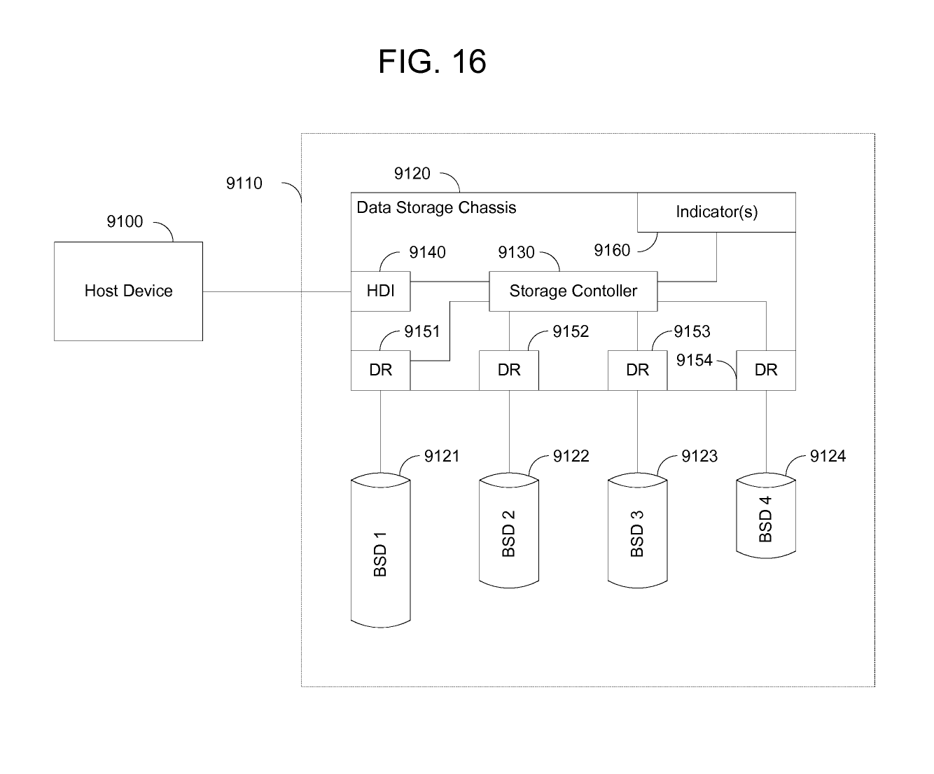

FIG. 16 is schematic block diagram showing relevant components of a computing environment in accordance with an exemplary embodiment of the invention. Generally speaking, a computing system embodiment includes a host device 9100 and a block-level storage system (BLSS) 9110. The host device 9100 may be any kind of computing device known in the art that requires data storage, for example a desktop computer, laptop computer, tablet computer, smartphone, or any other such device. In exemplary embodiments, the host device 9100 runs a host filesystem that manages data storage at a file level but generates block-level storage requests to the BLSS 9110, e.g., for storing and retrieving blocks of data.

In the exemplary embodiment shown in FIG. 16, BLSS 9110 includes a data storage chassis 9120 as well as provisions for a number of block storage devices (e.g., slots in which block storage devices can be installed). Thus, at any given time, the BLSS 9110 may have zero or more block storage devices installed. The exemplary BLSS 9110 shown in FIG. 16 includes four block storage devices 9121-9124, labeled “BSD 1” through “BSD 4,” although in other embodiments more or fewer block storage devices may be present.

The data storage chassis 9120 may be made of any material or combination of materials known in the art for use with electronic systems, such as molded plastic and metal. The data storage chassis 9120 may have any of a number of form factors, and may be rack mountable. The data storage chassis 9120 includes several functional components, including a storage controller 9130 (which also may be referred to as the storage manager), a host device interface 9140, block storage device receivers 9151-9154, and in some embodiments, one or more indicators 9160.

The storage controller 9130 controls the functions of the BLSS 9110, including managing the storage of blocks of data in the block storage devices and processing storage requests received from the host filesystem running in the host device 9100. In particular embodiments, the storage controller implements redundant data storage using any of a variety of redundant data storage patterns, for example, as described in U.S. Pat. Nos. 7,814,273, 7,814,272, 7,818,531, 7,873,782 and U.S. Publication No. 2006/0174157, each of which is hereby incorporated herein by reference in its entirety. For example, the storage controller 9130 may store some data received from the host device 9100 mirrored across two block storage devices and may store other data received from the host device 9100 striped across three or more storage devices. In this regard, the storage controller 9130 determines physical block addresses (PBAs) for data to be stored in the block storage devices (or read from the block storage devices) and generates appropriate storage requests to the block storage devices. In the case of a read request received from the host device 9100, the storage controller 9130 returns data read from the block storage devices 9121-9124 to the host device 9100, while in the case of a write request received from the host device 9100, the data to be written is distributed amongst one or more of the block storage devices 9121-9124 according to a redundant data storage pattern selected for the data.

Thus, the storage controller 9130 manages physical storage of data within the BLSS 9110 independently of the logical addressing scheme utilized by the host device 9100. In this regard, the storage controller 9130 typically maps logical addresses used by the host device 9100 (often referred to as a “logical block address” or “LBA”) into one or more physical addresses (often referred to as a “physical block address” or “PBA”) representing the physical storage location(s) within the block storage device. In the data storage systems described herein, the mapping between an LBA and a PBA may change over time (e.g., the storage controller 9130 in the BLSS 9110 may move data from one storage location to another over time). Further, a single LBA may be associated with several PBAs, e.g., where the associations are defined by a redundant data storage pattern across one or more block storage devices. The storage controller 9130 shields these associations from the host device 9100 (e.g., using the concept of zones), so that the BLSS 9110 appears to the host device 9100 to have a single, contiguous, logical address space, as if it were a single block storage device. This shielding effect is sometimes referred to as “storage virtualization.”

In exemplary embodiments disclosed herein, zones are typically configured to store the same, fixed amount of data (typically 1 gigabyte). Different zones may be associated with different redundant data storage patterns and hence may be referred to as “redundancy zones.” For example, a redundancy zone configured for two-disk mirroring of one 1 GB of data typically consumes 2 GB of physical storage, while a redundancy zone configured for storing 1 GB of data according to three-disk striping typically consumes 1.5 GB of physical storage. One advantage of associating redundancy zones with the same, fixed amount of data is to facilitate migration between redundancy zones, e.g., to convert mirrored storage to striped storage and vice versa. Nevertheless, other embodiments may use differently sized zones in a single data storage system. Different zones additionally or alternatively may be associated with different storage tiers, e.g., where different tiers are defined for different types of data, storage access, access speed, or other criteria.

Generally speaking, when the storage controller needs to store data (e.g., upon a request from the host device or when automatically reconfiguring storage layout due to any of a variety of conditions such as insertion or removal of a block storage device, data migration, etc.), the storage controller selects an appropriate zone for the data and then stores the data in accordance with the selected zone. For example, the storage controller may select a zone that is associated with mirrored storage across two block storage devices and accordingly may store a copy of the data in each of the two block storage devices.

Also, the storage controller 9130 controls the one or more indicators 9160, if present, to indicate various conditions of the overall BLSS 9110 and/or of individual block storage devices. Various methods for controlling the indicators are described in U.S. Pat. No. 7,818,531, issued Oct. 19, 2010, entitled “Storage System Condition Indicator and Method.” The storage controller 9130 typically is implemented as a computer processor coupled to a non-volatile memory containing updateable firmware and a volatile memory for computation. However, any combination of hardware, software, and firmware may be used that satisfies the functional requirements described herein.

The host device 9100 is coupled to the BLSS 9110 through a host device interface 9140. This host device interface 9140 may be, for example, a USB port, a Firewire port, a serial or parallel port, or any other communications port known in the art, including wireless. The block storage devices 9121-9124 are physically and electrically coupled to the BLSS 9110 through respective device receivers 9151-9154. Such receivers may communicate with the storage controller 9130 using any bus protocol known in the art for such purpose, including IDE, SAS, SATA, or SCSI. While FIG. 16 shows block storage devices 9121-9124 external to the data storage chassis 9120, in some embodiments the storage devices are received inside the chassis 9120, and the (occupied) receivers 9151-9154 are covered by a panel to provide a pleasing overall chassis appearance.

The indicators 9160 may be embodied in any of a number of ways, including as LEDs (either of a single color or multiple colors), LCDs (either alone or arranged to form a display), non-illuminated moving parts, or other such components. Individual indicators may be arranged to as to physically correspond to individual block storage devices. For example, a multi-color LED may be positioned near each device receiver 9151-9154, so that each color represents a suggestion whether to replace or upgrade the corresponding block storage device 9121-9124. Alternatively or in addition, a series of indicators may collectively indicate overall data occupancy. For example, ten LEDs may be positioned in a row, where each LED illuminates when another 10% of the available storage capacity has been occupied by data. As described in more detail below, the storage controller 9130 may use the indicators 9160 to indicate conditions of the storage system not found in the prior art. Further, an indicator may be used to indicate whether the data storage chassis is receiving power, and other such indications known in the art.

The storage controller 9130 may simultaneously use several different redundant data storage patterns internally within the BLSS 9110, e.g., to balance the responsiveness of storage operations against the amount of data stored at any given time. For example, the storage controller 9130 may store some data in a redundancy zone according to a fast pattern such as mirroring, and store other data in another redundancy zone according to a more compact pattern such as striping. Thus, the storage controller 9130 typically divides the host address space into redundancy zones, where each redundancy zone is created from regions of one or more block storage devices and is associated with a redundant data storage pattern. The storage controller 9130 may convert zones from one storage pattern to another or may move data from one type of zone to another type of zone based on a storage policy selected for the data. For example, to reduce access latency, the storage controller 9130 may convert or move data from a zone having a more compressed, striped pattern to a zone having a mirrored pattern, for example, using storage space from a new block storage device added to the system. Each block of data that is stored in the data storage system is uniquely associated with a redundancy zone, and each redundancy zone is configured to store data in the block storage devices according to its redundant data storage pattern.

### Transaction Aware Data Tiering

In a data storage system in accordance with various embodiments of the invention, each data access request is classified as pertaining to either a sequential access or a random access. Sequential access requests include requests for larger blocks of data that are stored sequentially, either logically or physically; for example, stretches of data within a user file. Random access requests include requests for small blocks of data; for example, requests for user file metadata (such as access or modify times), and transactional requests, such as database updates.

Various embodiments improve the performance of data storage systems by formatting the available storage media to include logical redundant storage zones whose redundant storage patterns are optimized for the particular type of access (sequential or random), and including in these zones the storage media having the most appropriate capabilities. Such embodiments may accomplish this by providing one or both of two distinct types of tiering: zone layout tiering and storage media tiering. Zone layout tiering, or logical tiering, allows data to be stored in redundancy zones that use redundant data layouts optimized for the type of access. Storage media tiering, or physical tiering, allocates the physical storage regions used in the redundant data layouts to the different types of zones, based on the properties of the underlying storage media themselves. Thus, for example, in physical tiering, storage media that have faster random I/O are allocated to random access zones, while storage media that have higher read-ahead bandwidth are allocated to sequential access zones.

Typically, a data storage system will be initially configured with one or more inexpensive hard disk drives. As application demands increase, higher-performance storage capacity is added. Logical tiering is used by the data storage system until enough high-performance storage capacity is available to activate physical tiering. Once physical tiering has been activated, the data storage system may use it exclusively, or may use it in combination with logical tiering to improve performance.

In order to facilitate tiering, available advertised storage in an exemplary embodiment is split into two pools: the transactional pool and the bulk pool. Data access requests are identified as transactional or bulk, and written to clusters from the appropriate pool in the appropriate tier. Data are migrated between the two pools based on various strategies discussed more fully below. Each pool of clusters is managed separately by a Cluster Manager, since the underlying zone layout defines the tier's performance characteristics.

A key component of data tiering is thus the ability to identify transactional versus bulk I/Os and place them into the appropriate pool. For the purposes of tiering as described herein, a transactional I/O is defined as being “small” and not sequential with other recently accessed data in the host filesystem's address space. The per-I/O size considered small may be, in exemplary embodiment, either 8 KiB or 16 KiB, the largest size commonly used as a transaction by the targeted databases. Other embodiments may have different thresholds for distinguishing between transactional I/O and bulk I/O. The I/O may be determined to be non-sequential based on comparison with the logical address of a previous request, a record of such previous request being stored in the J1 write journal.

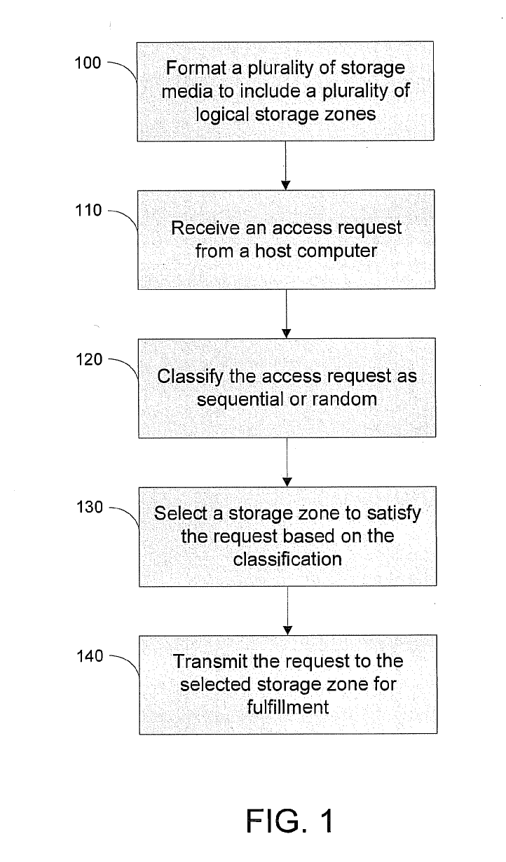

An overview of a method of operating the data storage system in accordance with an exemplary embodiment is shown in FIG. 1. In step 100 the data storage system formats a plurality of storage media to include a plurality of logical storage zones. In particular, some of these zones will be identified with the logical transaction pool, and some of these zones will be identified with the logical bulk pool. In step 110 the data storage system receives an access request from a host computer. The access request pertains to a read or write operation relevant to a particular fixed-size block of data, because, from the perspective of the host computer, the data storage system appears as to be a hard drive or other block-level storage device. In step 120 the data storage system classifies the received access request as either sequential (i.e., bulk) or random access (i.e., transactional). This classification permits the system to determine the logical pool to which the request pertains. In step 130, the data storage system selects a storage zone to satisfy the access request based on the classification of the access as transactional or bulk. Finally, in step 140 the data storage system transmits the request to the selected storage zone so that it may be fulfilled.

### Logical Tiering

Transactional I/Os are generally small and random, while bulk I/Os are larger and sequential. Generally speaking, the most space-efficient zone layout in any system with more than two disks is a parity stripe, i.e., HStripe or DRStripe. When a small write typical of a database transaction, e.g. 8 KiB, is written into a stripe, the entire stripe line must be read in order for the new parity to be computed as opposed to just writing the data twice in a mirrored zone. Although virtualization allows writes to disjoint host LBAs to be coalesced into contiguous ESA clusters, an exemplary embodiment has no natural alignment of clusters to stripe lines, making a read-modify-write on the parity quite likely. The layout of logical transactional zones avoid this parity update penalty, e.g., by use of a RAID-10 or MStripe (mirror-stripe) layout. Transactional reads from parity stripes suffer no such penalty, unless the array is degraded, since the parity data need not be read; therefore a logical transactional tier effectively only benefits writes. While there essentially is no disadvantage to reading transactional data from a parity stripe, there is also no advantage to servicing those reads from a transaction optimized zone, e.g. an MStripe.

Since there are essentially no performance benefits for reads from a logical transactional tier, there is limited advantage in allowing the tier to grow to a large size. A small logical transactional pool with old zones being background-converted to bulk zones should have the same performance profile as a tier containing all the transactional data. However there is a performance penalty for converting the zones, and once converted, the information that the zone contained transactional data would be lost. Maintaining the information about which zones contain transactional data may be made during a switch to physical tiering by allowing the tier to be automatically primed with known transactional data.

Transactional performance is heavily gated by the hit rate on cluster access table (CAT) records, which are stored in non-volatile storage. CAT records are cached in memory in a Zone MetaData Tracker (ZMDT). A cache miss forces an extra read from disk for the host I/O, thereby essentially nullifying any advantage from storing data in a higher-performance transactional zone. The performance drop off as ZMDT cache misses increase is likely to be significant, so there is little value in the hot data set in the transactional pool being larger than the size addressable via the ZMDT. This is another justification for artificially bounding the virtual transactional pool. A small logical transactional tier has the further advantage that the loss of storage efficiency is minimal and may be ignored when reporting the storage capacity of the data storage system to the host computer.

### Physical Tiering

SSDs offer access to random data at speed far in excess of what can be achieved with a mechanical hard drive. This is largely due to the lack of seek and head settle times. In a system with a line rate of 400 MB/s say, a striped array of mechanical hard drives can easily keep up when sequential accesses are performed. However, random I/O will typically be less than 3 MB/s regardless of the stripe size. Even a typical memory stick can out-perform that rate (hence the Windows 7 memory stick caching feature).

Even SSDs at the bottom end of the performance scale can exceed 100 MB/s in sequential access mode. While there is no seek and access time, random I/O performance will still fall short of the sequential value. This is because the transfers tend to be short and therefore have greater management overhead. Unfortunately, this random speed appears to be pretty independent of the sequential speed so it's hard to give a typical value and can range from 1/10 of the sequential speed (for a consumer device) to over 50% (for a server targeted device).

Zones in an exemplary physical transactional pool are located on media with some performance advantage, e.g. SSDs, high performance enterprise SAS disks, or hard disks being deliberately short stroked. Zones in the physical bulk pool may be located on less expensive hard disk drives that are not being short stroked. For example, the CAT tables and other Drobo metadata is typically accessed in small blocks accessed fairly often and accessed randomly. Storing this information in SSD zones allows lookups to be faster and those lookups cause less disruption to user data accesses. Random access data, such as file metadata, is typically written in small chunks. These small accesses also may be directed to SSD zones. However, user files, which typically consume much more storage space, may be stored on less expensive disk drives.

The physical allocation of zones in the physical transaction pool is optimized for the best random access given the available media, e.g. simple mirrors if two SSDs form the tier. Transactional writes to the physical transactional pool not only avoid any read-modify-write penalty on parity update, but also benefit from higher performance afforded by the underlying media. Likewise transactional reads gain a benefit from the performance of transactional tier, e.g. lower latency afforded by short stroking spinning disks or zero seek latency from SSDs.

The selection policy for disks forming a physical transactional tier is largely a product requirements decision and does not fundamentally affect the design or operation of the physical tiering. The choice can be based on the speed of the disks themselves, e.g. SSDs, or can simply be a set of spinning disks being short stroked to improve latency. Thus, some exemplary embodiments provide transaction-aware directed storage of data across a mix of storage device types including one or more disk drives and one or more SSD devices (systems with all disk drives or all SSD devices are essentially degenerate cases, as the system need not make a distinction between storage device types unless and until one or more different storage device types are added to the system).

With physical tiering, the size of the transactional pool is bounded by the size of the chosen media, whereas a logical transactional tier could be allowed to grow without arbitrary limit. An unbounded logical transactional pool is generally undesirable from a storage efficiency point of view, so “cold” zones will be migrated into the bulk pool. It is possible (although not required) for the transactional pool to span from a physical into a logical tier.

Separating the transactional data from the bulk data in this way brings several benefits, including removing the media contention with the bulk data, so that long read-ahead operations are no longer interrupted by short random accesses. A characteristic of the physical tier is that its maximum size is constrained by the media hosting it. The size constraint guarantees that eventually the physical tier will become full and so requires a policy to trim the contents in a manner that best affords the performance advantages of the tier to be maintained.

The introduction of a physical tier also requires a policy for management of the tier when it becomes degraded. A tradeoff must be made between maintaining tiering performance by delaying a degraded relayout in the hopes the fast media will be replaced in a timely manner versus an immediate repair into the remaining magnetic media. A relayout into the magnetic media impacts transactional performance, but is the safest course of action.

In summary, logical tiering improves transactional write performance but not transactional read performance, whereas physical tiering improves both transactional read and write performance. Furthermore, the separation of bulk and transactional data to different media afforded by physical tiering reduces head seeking on the spinning media, and as a result allows the system to better maintain performance under a mixed transactional and sequential workload.

### Transactional Writes

There are two options for dealing with writes to the transactional tier that hit a host LBA for which there is already a cluster: allocate a new cluster and free the old one (the “realloc” strategy), or overwrite the old cluster in place (the “overwrite” strategy). There are advantages and disadvantages to each approach.

Allocating new clusters has the benefit that the system can coalesce several host writes, regardless of their host LBAs, into a single write down the storage system stack. One advantage here is reducing the passes down the stack and writing a single disk I/O for all the host I/Os in the coalesced set. However, the metadata still needs to be processed, which would likely be a single cluster allocate plus cluster deallocate for each host I/O in the set. These I/Os go through the J2 journal and so can themselves be coalesced or de-duplicated and are amortized across many host writes.

By contrast, overwriting clusters in place enables skipping metadata updates at the cost of a trip down the stack and a disk head seek for each host I/O. Cluster Scavenger operations require that the time of each cluster write be recorded in the cluster's CAT record. This is addressed in order to remove the CAT record updates when overwriting clusters in place, e.g., by recording the time at a lower frequency or even skip scavenging on the transactional tier.

Trading the stack traversals for metadata updates against disk head seeks is an advantage only if the disk seeks are free, as with SSD.

### Hybrid HDD/SSD Zones

A single SSD in a mirror with a magnetic disk could be used to form the physical transactional tier. All reads to the tier preferably would be serviced exclusively from the SSD and thereby deliver the same performance level as a mirror pair of SSDs. Writes would perform only at the speed of the magnetic disk, but the write journal architecture hides write latency from the host computer. The magnetic disk is isolated from the bulk pool and also short stroked to further mitigate this write performance drag.

One issue with slower back-end transactional writes is the stack's ability to clear the J1 write journal. Transactions lingering in the journal could eventually generate back pressure that would be visible to the host. This problem may be solved by using two J1 write journals, one for each access pool. A typical allocation of J1 memory is 192 MiB for the bulk pool (using 128 KiB buffers) and 12 MiB for the transactional pool (using 16K/32K buffers). A tier split in this way uses the realloc write policy to permit higher IOPS in the bulk pool, but may use the overwrite strategy in the transactional pool. The realloc strategy allows coalescing of host writes into a smaller number of larger disks I/Os and offsets the performance deficiency of the magnetic half of the tier. However, this problem is not present in SSDs, so the overwrite strategy is more efficient in the transactional pool. A high end SAS disk capable of around 150 IOPS would need an average of about 6 host I/Os to be written in a single back-end write.

If SSDs are to be used in a way that makes use of their improved random performance, it would be preferable to use the SSDs independently of hard disks where possible. As soon as an operation becomes dependent on a hard disk, the seek/access times of the disk generally will swamp any gains made by using the SSD. This means that the redundancy information for a given block on a SSD should also be stored on an SSD. In a case where the system only has a single SSD or only a single SSD has available storage space, this is not possible. In this case the user data may be stored on the SSD, while the redundancy data (such as a mirror copy) is stored on the hard disk. In this way, random reads, at least, will benefit from using the SSD. In the event that a second SSD is inserted or storage space becomes available on a second SSD (e.g., through a storage space recovery process), however, the redundancy data on the hard disk may be moved to the SSD for better write performance.

As an example of the increased performance gained by using an SSD/HDD hybrid configuration, consider the following calculation. Assuming a transactional workload of 75% read and 25% write operations at 400 I/O operations per second (IOPS) and 100 MB/s bulk writes (which is another 400 IOPS if the write block size is 256K), an array of 12 HDD will require: 25 IOPS/disk for the transactional reads; 42 IOPS/disk for the transactional writes; and 50 IOPS/disk for the bulk writes (assuming each I/O thread writes 2 MB to all of the disks at once in a redundant data layout). Thus, a little over 100 IOPS/disk are required. This is difficult to do with SATA disks, but is possible with SAS.

However, with 11 magnetic HDD having one HDD paired with a single SSD: the 300 transactional reads come from the SSD (as described above); the 100 writes each require only a single write to 11 HDD, or 9 IOPS/disk; and the bulk writes are again 50 IOPS/disk. Thus, the hybrid embodiment only requires about 60 IOPS per magnetic disk, which can be achieved with the less expensive technology. (With 2 SSDs, the number is reduced to 50 IOPS/HDD, a 50% reduction in workload on the magnetic disks.)

### Reconfiguration and Compaction

In some embodiments of the present invention, management of each logical storage pool is based not only on the amount of storage capacity available and the existing storage patterns at a given time but also based on the types of storage devices in the array and in some cases based on characteristics of the data being stored (e.g., filesystem metadata or user data, frequently accessed data or infrequently accessed data, etc.). Exemplary embodiments may thus incorporate the types of redundant storage described in U.S. Pat. No. 7,814,273, mentioned above. For the sake of simplicity or convenience, storage devices (whether disk drives or SSD devices) may be referred to below in some places generically as disks or disk drives.

A storage manager in the storage system detects which slots of the array are populated and also detects the type of storage device in each slot and manages redundant storage of data accordingly. Thus, for example, redundancy may be provided for certain data using only disk drives, for other data using only SSD devices, and still other data using both disk drive(s) and SSD device(s).

For example, mirrored storage may be reconfigured in various ways, such as:
data that is mirrored across two disk drives may be reconfigured so as to be mirrored across one disk drive and one SSD device;
data that is mirrored across two disk drives may be reconfigured so as to be mirrored across two SSD devices;
data that is mirrored across one disk drive and one SSD device may be reconfigured so as to be mirrored across two SSD devices;
data that is mirrored across two SSD devices may be reconfigured so as to be mirrored across one disk drive and one SSD device;
data that is mirrored across two SSD devices may be reconfigured so as to be mirrored across two disk drives;
data that is mirrored across one disk drive and one SSD device may be reconfigured so as to be mirrored across two disk drives.

Striped storage may be reconfigured in various ways, such as:
data that is mirrored across three disk drives may be reconfigured so as to be striped across two disk drives and an SSD drive, and vice versa;
data that is mirrored across two disk drives and an SSD drive may be reconfigured so as to be striped across one disk drive and two SSD drives, and vice versa;
data that is mirrored across one disk drive and two SSD drives may be reconfigured so as to be striped across three SSD drives, and vice versa;
data that is striped across all disk drives may be reconfigured so as to be striped across all SSD drives, and vice versa.

Mirrored storage may be reconfigured to striped storage and vice versa, using any mix of disk drives and/or SSD devices. Data may be reconfigured based on various criteria, such as, for example, when a SSD device is added or deleted, or when storage space becomes available or unavailable on an SSD device, or if higher or lower performance is desired for the data (e.g., the data is being frequently or infrequently accessed). If an SSD fails or is removed, data may be compacted (i.e., its logical storage zone redundant data layout may be changed to be more space-efficient). If so, the new, compacted data is located in the bulk tier (which is optimized for space-efficiency), not the transactional tier (which is optimized for speed). This layout process occurs immediately, but if the transactional pool becomes non-viable, its size is increased to compensate. If all SSDs fail, physical tiering is disabled and the system reverts to logical tiering exclusively.

The types of reconfiguration described above can be generalized to two different tiers, specifically a lower-performance tier (e.g., disk drives) and a higher-performance tier (e.g., SSD devices, high performance enterprise SAS disks, or disks being deliberately short stroked), as described above. Furthermore, the types of reconfiguration described above can be broadened to include more than two tiers.

### Physical Transactional Tier Size Management

Given that a physical transactional pool has a hard size constraint, e.g. SSD size or restricted HDD seek distance, it follows that the tier may eventually become full. Even if the physical tier is larger than the transactional data set, it can still fill as the hot transactional data changes over time, e.g. a new database is deployed, new emails arrive daily, etc. The system's transactional write performance is heavily dependent on transactional writes going to transactional zones and so the tier's contents is managed so as to always have space for new writes.

The transactional tier can fill broadly in two ways. If the realloc strategy is in effect, the system can run out of regions and be unable to allocate new zones even when there are a significant amount of free clusters available. The system continues to allocate from the transactional tier but will have to find clusters in existing zones and will be forced to use increasingly less efficient cluster runs. If the overwrite strategy is in operation, filling the tier requires the transactional data set to grow. New cluster allocation on all writes will likely require the physical tier to trim more aggressively than the cluster overwrite mode of operation. Either way the tier can fill and trimming will become necessary.

The layout of clusters in the tier may be quite different depending on the write allocation policy in effect. In the overwrite case, there is no relationship between a cluster's location and age, whereas in the realloc case, clusters in more recently allocated zones are themselves younger. In both cases, a zone may contain both recently written, and presumably hot clusters, and older and colder clusters. Despite this intermixing of hot and cold data it is still more efficient to trim the transactional tier via zone re-layouts, rather than copying of cluster contents. When a zone is trimmed from the physical transactional tier in this manner, any hot data is migrated back into the tier through a bootstrapping process described below in the section “Bootstrapping the Transactional Tier.”

Since any zone in the physical transactional tier may contain hot as well as cold data, randomly evicting zones when the tier needs to be trimmed is reasonable. However, a small amount of tracking information can provide a much more directed eviction policy. Tracking the time of last access on a per zone basis can give some measure of the “hotness” of a zone but since the data in the tier is random could easily be fooled by a lone recent access. Tracking the number of hits on a zone over a time period should give a far more accurate measure of historical temperature. Note though that since the data in the tier is random historical hotness is no guarantee of future usefulness of the data.

Tracking access to the zones in the transactional tier is an additional overhead. It is prohibitively expensive to store that data in the array metadata on every host I/O. Instead the access count is maintained in core memory, and only written to the disk array periodically. This allows the access tracking to be reloaded with some reasonable degree of accuracy after a system restart.

When it becomes necessary to evict a zone from the transactional tier to the bulk tier, the least useful transactional zones are evicted from the physical tier by marking them for re-layout to bulk zones. After an eviction cycle, the tracking data are reset to prevent a zone that had been very hot but has gone cold from artificially hanging around in the transaction tier.

### Low Space Conditions

If a cluster allocation cannot be satisfied from the desired pool, a data storage system may fulfill it from the other pool. This can mean that the bulk pool contains transactional data or the transactional pool contains bulk data, but since this is an extreme low cluster situation, it is not common

It is possible that a system that is overdue for data compaction, perhaps because of high host loads, can run out of free zones and force transactional data into bulk zones even though there is significant amount of free space available. In this situation both streaming and transactional performance will be adversely affected. This condition will be avoided by modifications to the background scheduler to ensure background jobs make useful progress even under constant host load.

### Metadata Caching Effects

Each host I/O requires access to array metadata and thus spawns one or more internal I/Os. For a host read, the system must first read the CAT record in order to locate the correct zone for the host data, and then read the host data itself. For a host write, the system must read the CAT record, or allocate a new one, and then write it back with the new location of the host data. These additional I/Os are easily amortized in streaming workloads but become prohibitively expensive in transactional loads. The system maintains a cache of CAT records in the Zone MetaData Tracker (ZMDT) cache. In order to deliver reasonable transactional performance the system effectively must sustain a high hit rate from this cache.

The ZMDT typically is sized such that the CAT records for the hot transactional data fit entirely inside the cache. The ZMDT size is constrained by the platform's RAM as discussed in the “Platform Considerations” section below. As further discussed therein, the ZMDT operates so that streaming I/Os never displace transactional data from the cache. This is accomplished by using a modified LRU scheme that reserves a certain percentage of the ZMDT cache for transactional I/O data at all times.

### Bootstrapping the Transactional Tier

When a system is loaded with data for the first time or rebooted, the context provided by the way the data was accessed is either not available or is misleading.

Transactional performance relies on correctly identifying transactional I/Os and handling them in some special way. However, when a system is first loaded with data, it is very likely that the databases will be sequentially written to the array from a tape backup or another disk array. This will defeat identification of the transactional data and the system will pay a considerable “boot strap” penalty when the databases are first used in conjunction with a physical transactional tier since the tier will initially be empty. Transactional writes made once the databases are active will be correctly identified and written to the physical tier but reads from data sequentially loaded will have to be serviced from the bulk tier. To reduce this boot strap penalty, transactional reads serviced from the bulk pool may be migrated to the physical transactional tier—note that no such migration is necessary if logical tiering is in effect.

This migration will be cluster based and so much less efficient than trimming from the pool. In order to minimize impact on the system's performance, the migration will be carried out in the background and some relatively short list of clusters to move will be maintained. When the migration of a cluster is due, it will only be performed if the data is still in the Host LBA Tracker (HLBAT) cache and so no additional read will be needed. A block of clusters may be moved under the assumption that the database resides inside one or more contiguous ranges of host LBAs. All clusters contiguous in the CLT up to a sector, or cluster, of CLT may be moved en masse.

After a system restart, the ZMDT will naturally be empty and so transactional I/O will pay the large penalty of cache misses caused by the additional I/O required to load the array's metadata. Some form of ZMDT pre-loading may be performed to avoid a large boot strap penalty under transactional workloads.

For example, the addresses of the CLT sectors may be stored in the transactional part of the cache periodically. This would allow those CLT sectors to be pre-loaded during a reboot enabling the system to boot with an instantly hot ZMDT cache.

The ZMDT of an exemplary embodiment is as large as 512 MiB, which is enough space for over 76 million CAT records. The ZMDT granularity is 4 KiB, so a single ZMDT entry holds 584 CLT records. If the address of each CLT cluster were saved, 131,072 CLT sector addresses would have to be tracked. Each sector of CLT is addressed with zone number and offset which together require 36 bits (18 bits for zone number and 18 bit for CAT). Assuming the ZMDT ranges are managed unpacked, the system would need to store 512 KiB to track all possible CLT clusters that may be in the cache. This requirement may be further reduced because the ZMDT will also contain CM's cluster bitmaps and part of the ZMDT will be hived off for non-transactionally accessed CLT ranged. Even this exemplary worst case 512 KiB is manageable and a reasonable price to pay for the benefit of pre-warming the cache on startup.

The data that needs to be saved is in fact already in the cache's index structure, implemented in an exemplary embodiment as a splay tree.

### Sequential Access to Transactional Data

Many databases are accessed sequentially once per day whilst backups are taking place. During these backups, the transactional data are accessed sequentially. During this process, the system must not mark transactional clusters as sequential, or these clusters might be written to an inefficient zone.

One solution is that once a cluster is placed in a zone and that zone is marked transactional, it is never re-categorized as sequential. Moreover a range of CAT records in the ZMDT marked as transactional should not be moved to the sequential LRU insert point even if they are accessed sequentially. A nightly database backup would register a read I/O against every cluster in all transactional zones and so no special processing ought to be required to discount these accesses from the ‘trim tracking’. If incremental backups are being performed the sequential accesses should only hit the records written since the previous backup and so again no special processing ought to be required.

There is some evidence that heavy fragmentation in host LBA space of transactional data sets can cause extremely poor sequential read performance. A typical Microsoft Exchange database backs up at 2 MiB/s, likely due to fragmentation of the transaction pool. In one embodiment, defragmentation on the transactional zones is used in order to improve this rate and guarantee reasonable backup times.

### Platform Considerations

A typical embodiment of the data storage system has 2 GiB of RAM including 1 GiB protectable by battery backup. The embodiment runs copies of Linux and VxWorks. It provides a J1 write journal, a J2 metadata journal, Host LBA Tracker (HLBAT) cache and Zone Meta Data Tracker (ZMDT) cache in memory. The two operating systems consume approximately 128 MiB each and use a further 256 MiB for heap and stack, leaving approximately 1.5 GiB for the caches. The J1 and J2 must be in the non-volatile section of DRAM and together must not exceed 1 GiB. Assuming 512 MiB for J1 and J2 and a further 512 MiB for HLBAT the system should also be able to accommodate a ZMDT of around 512 MiB. A 512 MiB ZMDT can entirely cache the CAT records for approximately 292 GiB of HLBA space.

The LRU accommodates both transactional and bulk caching by inserting new transactional records at the beginning of the LRU list, but inserting new bulk records farther down the list. In this way, the cache pressure prefers to evict records from the bulk pool wherever possible. Further, transactional records are marked “prefer retain” in the LRU logic, while bulk records are marked “evict immediate”. The bulk I/O CLT record insertion point is set at 90% towards the end of the LRU, essentially giving around 50 MiB of ZMDT over to streaming I/Os and leaving around 460 MiB for transactional entries. Even conservatively assuming 50% of the ZMDT will be available for transactional CLT records, the embodiment should comfortably service 150 GiB of hot transactional data. This size can be further increased by tuning down the HLBAT and J1 allocations and the OS heaps. The full 460 MiB ZMDT allocation would allow for 262 GiB of hot transactional data.

Note that if the amount of transactional data on the system is significantly larger than the hot sets, the embodiment can degenerate to using a single host user data cluster per cluster of CLT records in the ZMDT. This would effectively reduce the transactional data cacheable in the ZMDT to only 512 MiB, assuming the entire 512 MiB ZMDT was given over to CLT records. This is possible because ZMDT entries have a 4 KiB granularity, i.e. 8 CLT, sectors but in a large truly random data set only a single CAT record in the CLT cluster may be hot.

### Metadata in SSDs

Transactional performance is expected to drop off rapidly as the rate of ZMDT cache misses for CLT record reads increases. The exact point at which the ZMDT miss rate drops the transactional performance bellow acceptable levels is not currently understood but it seems clear that a physical tier significantly larger than the ZMDT serves little purpose. There is some fuzziness here however, hot sets can change over time and zones may contain both hot and cold data. Nevertheless the physical tier can be trimmed to a size relatively close to the ZMDT size with little or no negative performance impact.

If the SSDs have free space beyond the need of the transactional user data some ESA metadata could be located there. Most useful would be the CLT records for the transactional data and the CM bitmaps. The system has over 29 GiB of CLT records for a 16 TiB zone so most likely only the subset of CLT in use for the transactional data should be moved into SSDs. Alternatively there may be greater benefit from locating CLT records for non-transactional data in the SSDs since the transactional ones ought to be in the ZMDT cache anyway. This would also reduce head seeks on the mechanical disks for streaming I/Os.

The benefit of locating metadata in SSDs is marginal in a system that is CPU bound. However, this feature returns greater dividends in systems with more powerful CPUs.

### SSD Sector Discards

For best performance, in an example embodiment a sector discard command, TRIM for ATA and UNMAP for SCSI, is sent to an SSD when a sector is no longer in use. Thus discarded, the sector is erased by the SSD and made ready for re-use in the background. A performance penalty can be incurred if writes are made to an in-use sector whilst the SSD performs the erase step necessary for sector re-use.

SSD discards are required whenever a cluster is freed back to CM ownership and whenever a cluster zone itself is deleted. Discards are also performed whenever a Region located on an SSD is deleted, e.g. during a re-layout.

SSD discards have several potential implications over and above the cost of the implementation itself. Firstly, in some commercial SSDs, reading from a discarded sector does not guarantee zeros are returned and it is not clear whether the same data is always returned. Thus, during a discard operation the Zone Manager must recompute the parity for any stripe containing a cluster being discarded. Normally this is not required since a cluster being freed back to CM does not change the clusters contents. If the cluster's contents changed to zero, the containing stripe's parity would still need to be recomputed but the cluster itself would not need to be re-read. If the cluster's contents were not guaranteed to be zero the cluster would have to be read in order for the parity to be maintained. If the data read from a discarded cluster were able to change between reads discards would not be supportable in stripes.

Secondly, some SSDs have internal erase boundaries and alignments that cannot be crossed with a single discard command. This means that an arbitrary sector may not be erasable, although since the system operates largely in clusters itself this may not be an issue. The erase boundaries are potentially more problematic since a large discard may only be partially handled and terminated at the boundary. For example, if the erase boundaries were at 256 KiB and a 1 MiB discard was sent the erase would terminate at the first boundary and the remaining sectors in the discard would remain in use. This would require the system to read the contents of all clusters erased in order to determine exactly what had happened. Note that this may be required because of non-zero read issue discussed above.

Transactional performance requirements are relatively modest, and even with the penalty from not discarding, SSD performance may be sufficient.

### Targeted Defragmentation

As noted earlier, not performing any defragmentation on the transactional tier may result in poor streaming reads from the tier, e.g., during backups. The transactional tier may fragment very quickly if the write policy is realloc and not overwrite based. In this case a defrag frequency of, say, once every 30 days is likely to prove insufficient to restore reasonable sequential access performance. A more frequent defrag targeted at only the HLBA ranges containing transactional data is a possible option. The range of HLBA to be defragmented can be identified from the CLT records in the transactional part of the ZMDT cache. In fact the data periodically written to allow the ZMDT pre-load is exactly the range of CLT records a transactional defrag should operate on. Note that this would only target hot transactional data for defragmentation; the cold data should not be suffering from increasing fragmentation.

### Data Monitoring

An exemplary embodiment monitors information related to a given LBA or cluster, such as frequency of read/write access, last time accessed and whether it was accessed along with its neighbors. That data is stored in the CAT records for a given LBA. This in turn allows the system to make smart decisions when moving data around, such as whether to keep user data that is accessed often on an SSD or whether to move it to a regular hard drive. The system determines if non-LBA adjacent data is part of the same access group so that it stores that data for improved access or to optimize read-ahead buffer fills.

### Automatic Tier Generation

In some embodiments, logical storage tiers are generated automatically and dynamically by the storage controller in the data storage system based on performance characterizations of the block storage devices that are present in the data storage system and the storage requirements of the system as determined by the storage controller.

Specifically, the storage controller automatically determines the types of storage tiers that may be required or desirable for the system at the block level and automatically generates one or more zones for each of the tiers from regions of different block storage devices that have, or are made to have, complementary performance characteristics. Each zone is typically associated with a predetermined redundant data storage pattern such as mirroring (e.g. RAID1), striping (e.g. RAID5), RAID6, dual parity, diagonal parity, low density parity check codes, turbo codes, and other similar redundancy schemes, although technically a zone does not have to be associated with redundant storage. Typically, redundancy zones incorporate storage from multiple different block storage devices (e.g., for mirroring across two or more storage devices, striping across three or more storage devices, etc.), although a redundancy zone may use storage from only a single block storage device (e.g., for single-drive mirroring or for non-redundant storage).

The storage controller may establish block-level storage tiers for any of a wide range of storage scenarios, for example, based on such things as the type of access to a particular block or blocks (e.g., predominantly read, predominantly write, read-write, random access, sequential access, etc.), the frequency with which a particular block or range of blocks is accessed, the type of data contained within a particular block or blocks, and other criteria including the types of physical and logical tiering discussed above. The storage controller may establish virtually any number of tiers.

The storage controller may determine the types of tiers for the data storage system using any of a variety of techniques. For example, the storage controller may monitor accesses to various blocks or ranges of blocks and determine the tiers based on such things as access type, access frequency, data type, and other criteria. Additionally or alternatively, the storage controller may determine the tiers based on information obtained directly or indirectly from the host device such as, for example, information specified by the host filesystem or information “mined” from host filesystem data structures found in blocks of data provided to the data storage system by the host device (e.g., as described in U.S. Pat. No. 7,873,782 entitled Filesystem-Aware Block Storage System, Apparatus, and Method, which is hereby incorporated herein by reference in its entirety).

In order to create appropriate zones for the various block-level storage tiers, the storage controller may reconfigure the storage patterns of data stored in the data storage system (e.g., to free up space in a particular block storage device) and/or reconfigure block storage devices (e.g., to format a particular block storage device or region of a block storage device for a particular type of operation such as short-stroking).

A zone can incorporate regions from different types of block storage devices (e.g., an SSD and an HDD, different types of HDDs such as a mixture of SAS and SATA drives, HDDs with different operating parameters such as different rotational speeds or access characteristics, etc.). Furthermore, different regions of a particular block storage device may be associated with different logical tiers (e.g., sectors close to the outer edge of a disk may be associated with one tier while sectors close to the middle of the disk may be associated with another tier).

The storage controller evaluates the block storage devices (e.g., upon insertion into the system and/or at various times during operation of the system as discussed more fully below) to determine performance characteristics of each block level storage device such as the type of storage device (e.g., SSD, SAS HDD, SATA HDD, etc.), storage capacity, access speed, formatting, and/or other performance characteristics. The storage controller may obtain certain performance information from the block storage device (e.g., by reading specifications from the device) or from a database of block storage device information (e.g., a database stored locally or accessed remotely over a communication network) that the storage controller can access based on, for example, the block storage device serial number, model number or other identifying information. Additionally or alternatively, the storage controller may determine certain information empirically, such as, for example, dynamically testing the block storage device by performing storage accesses to the device and measuring access times and other parameters. As mentioned above, the storage controller may dynamically format or otherwise configure a block storage device or region of block storage device for a desired storage operation, e.g., formatting a HDD for short-stroking in order to use storage from the device for a high-speed storage zone/tier.

Based on the tiers determined by the storage controller, the storage controller creates appropriate zones from regions of the block storage devices. In this regard, particularly for redundancy zones, the storage controller creates each zone from regions of block storage devices having complementary performance characteristics based on a particular storage policy selected for the zone by the storage controller. In some cases, the storage controller may create a zone from regions having similar complementary performance characteristics (e.g., high-speed regions on two block storage devices) while in other cases the storage controller may create a zone from regions having dissimilar complementary performance characteristics, based on storage policies implemented by the storage controller (e.g., a high-speed region on one block storage device and a low-speed region on another block storage device).

In some cases, the storage controller may be able to create a particular zone from regions of the same type of block storage devices, such as, for example, creating a mirrored zone from regions on two SSDs, two SAS HDDs, or two SATA HDDs. In various embodiments, however, it may be necessary or desirable for the storage controller to create one or more zones from regions on different types of block storage devices, for example, when regions from the same type of block storage devices are not available or based on a storage policy implemented by the storage controller (e.g., trying to provide good performance while conserving high-speed storage on a small block storage device). For convenience, zones intentionally created for a predetermined tiered storage policy from regions on different types of block storage devices or regions on similar types of block storage devices but having different but complementary performance characteristics may be referred to herein as “hybrid” zones. It should be noted that this concept of a hybrid zone refers to the intentional mixing of different but complementary regions to create a zone/tier having predetermined performance characteristics, as opposed to, for example, the mixing of regions from different types of block storage devices simply due to different types of block storage devices being installed in a storage system (e.g., a RAID controller may mirror data across two different types of storage devices if two different types of storage devices happen to be installed in the storage system, but this is not a hybrid mirrored zone within the context described herein because the regions of the different storage devices were not intentionally selected to create a zone/tier having predetermined performance characteristics).

For example, a hybrid zone/tier may be created from a region of an SSD and a region of an HDD, e.g., if only one SSD is installed in the system or to conserve SSD resources even if multiple SSDs are installed in the system. Among other things, such SSD/HDD hybrid zones may allow the storage controller to provide redundant storage while taking advantage of the high-performance of the SSD.

One type of exemplary SSD/HDD hybrid zone may be created from a region of an SSD and a region of an HDD having similar performance characteristics, such as, for example, a region of a SAS HDD selected and/or configured for high-speed access (e.g., a region toward the outer edge of the HDD or a region of the HDD configured for short-stroking). Such an SSD/HDD hybrid zone may allow for high-speed read/write access from both the SSD and the HDD regions, albeit with perhaps a bit slower performance from the HDD region.

Another type of exemplary SSD/HDD hybrid zone may be created from a region of an SSD and a region of an HDD having dissimilar performance characteristics, such as, for example, a region of a SATA HDD selected and/or configured specifically for lower performance (e.g., a region toward the inner edge of the HDD or a region in an HDD suffering from degraded performance). Such an SSD/HDD hybrid zone may allow for high-speed read/write access from the SSD region, with the HDD region used mainly for redundancy in case the SSD fails or is removed (in which case the data stored in the HDD may be reconfigured to a higher-performance tier).

Similarly, a hybrid zone/tier may be created from regions of different types of HDDs or regions of HDDs having different performance characteristics, e.g., different rotation speeds or access times.

One type of exemplary HDD/HDD hybrid zone may be created from regions of different types of HDDs having similar performance characteristics, such as, for example, a region of a high-performance SAS HDD and a region of a lower-performance SATA HDD selected and/or configured for similar performance. Such an HDD/HDD hybrid zone may allow for similar performance read/write access from both HDD regions.

Another type of exemplary HDD/HDD hybrid zone may be created from regions of the same type of HDDs having dissimilar performance characteristics, such as, for example, a region of an HDD selected for higher-speed access and a region of an HDD selected for lower-speed access (e.g., a region toward the inner edge of the SATA HDD or a region in a SATA HDD suffering from degraded performance). In such an HDD/HDD hybrid zone, the higher-performance region may be used predominantly for read/write accesses, with the lower-performance region used mainly for redundancy in case the primary HDD fails or is removed (in which case the data stored in the HDD may be reconfigured to a higher-performance tier).

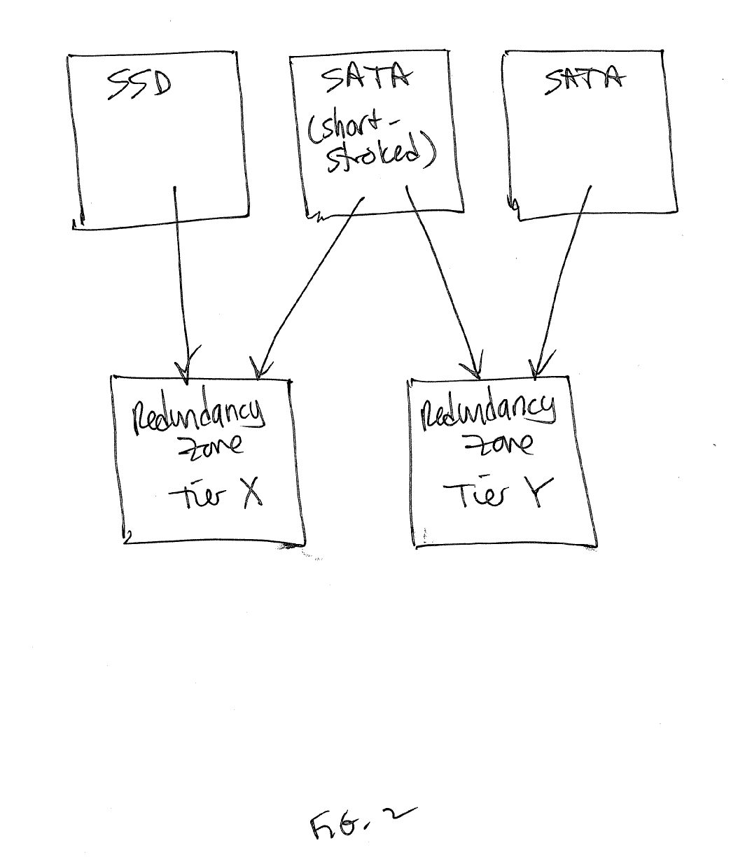

FIG. 2 schematically shows hybrid redundancy zones created from a mixture of block storage device types, in accordance with an exemplary embodiment. Here, Tier X encompasses regions from an SSD and a SATA HDD configured for short-stroking, and Tier Y encompasses regions from the short-stroked SATA HDD and from a SATA HDD not configured for short-stroking.

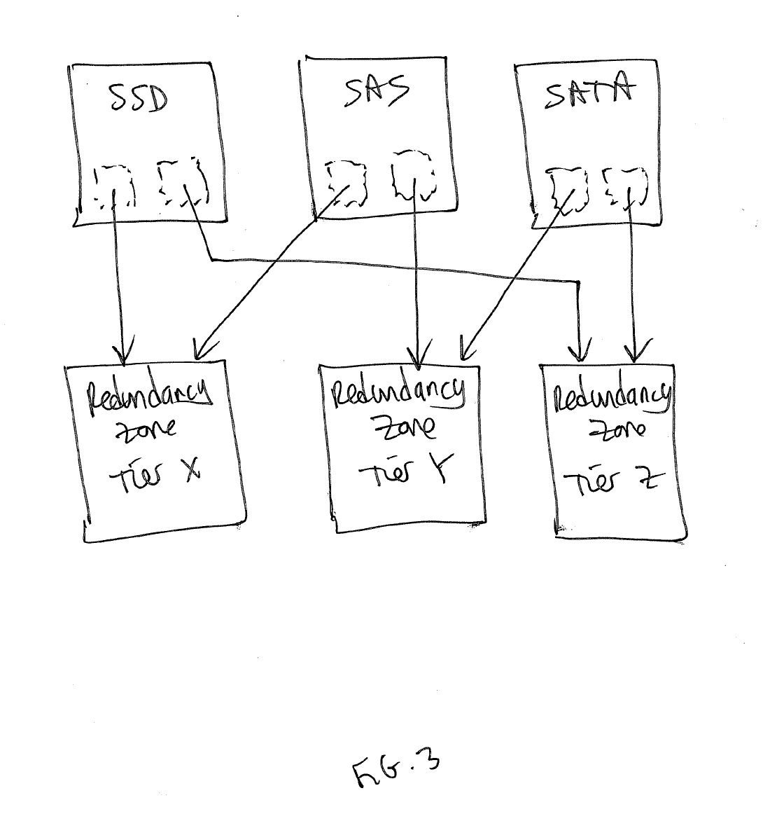

FIG. 3 schematically shows hybrid redundancy zones created from a mixture of block storage device types, in accordance with an exemplary embodiment. Here, Tier X encompasses regions from an SSD and a SAS HDD (perhaps a high-speed tier, where the regions from the SAS are relatively high-speed regions), Tier Y encompasses regions from the SAS HDD and a SATA HDD (perhaps a medium-speed tier, where the regions of the SATA are relatively high-speed regions), and Tier Z encompasses regions from the SSD and SATA HDD (perhaps a high-speed tier, where the SATA regions are used mainly for providing redundancy but are typically not used for read/write accesses).

Furthermore, redundancy zones/tiers may be created from different regions of the exact same types of block storage devices. For example, multiple logical storage tiers can be created from an array of identical HDDs, e.g., a “high-speed” redundancy zone/tier may be created from regions toward the outer edge of a pair of HDDs while a “low-speed” redundancy zone/tier may be created from regions toward the middle of those same HDDs.

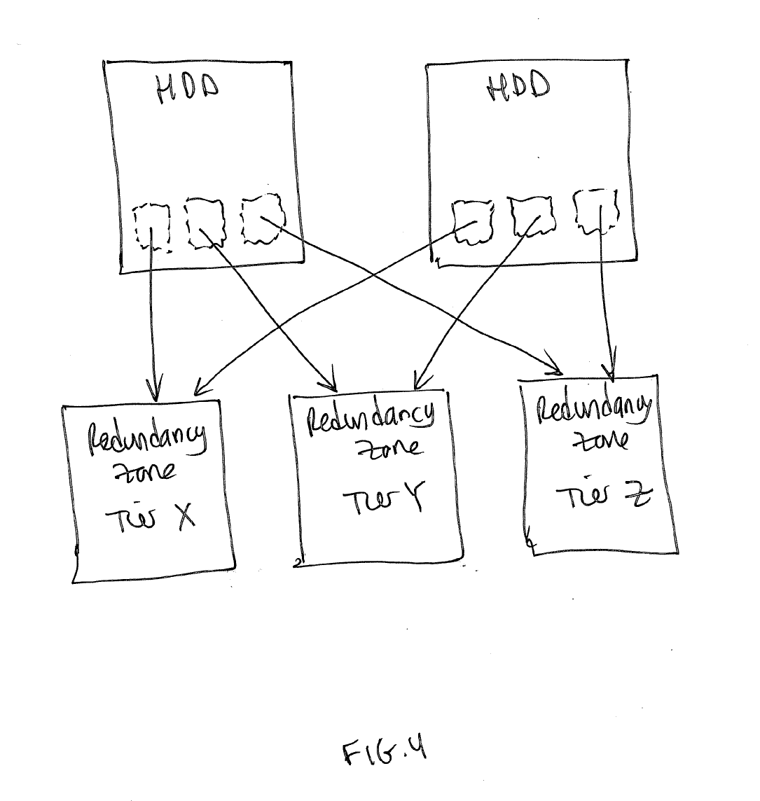

FIG. 4 schematically shows redundancy zones creates from regions of the same types and configurations of HDDs, in accordance with an exemplary embodiment. Here, three tiers of storage are shown, with each tier encompassing corresponding regions from the HDDs. For example, Tier X may be a high-speed tier encompassing regions along the outer edge of the HDDs, Tier Y may be a medium-speed tier encompassing regions in the middle of the HDDs, and Tier Z may be a low-speed encompassing regions toward the center of the HDDs.

Thus, as mentioned above, different regions of a particular block storage device may be associated with different redundancy zones/tiers. Thus, for example, one region of an SSD may be included in a high-speed zone/tier while another region of an SSD may be included in a lower-speed zone/tier. Similarly, different regions of a particular HDD may be included in different zones/tiers.

It also should be noted that, in creating/managing zones, the storage controller may move a block storage device or region of a block storage device from a zone in one tier to a zone in a different tier. Thus, for example, in creating/managing zones, the storage controller essentially may carve up one or more existing zones to create additional tiers, and, conversely, may consolidate storage to reduce the number of tiers.

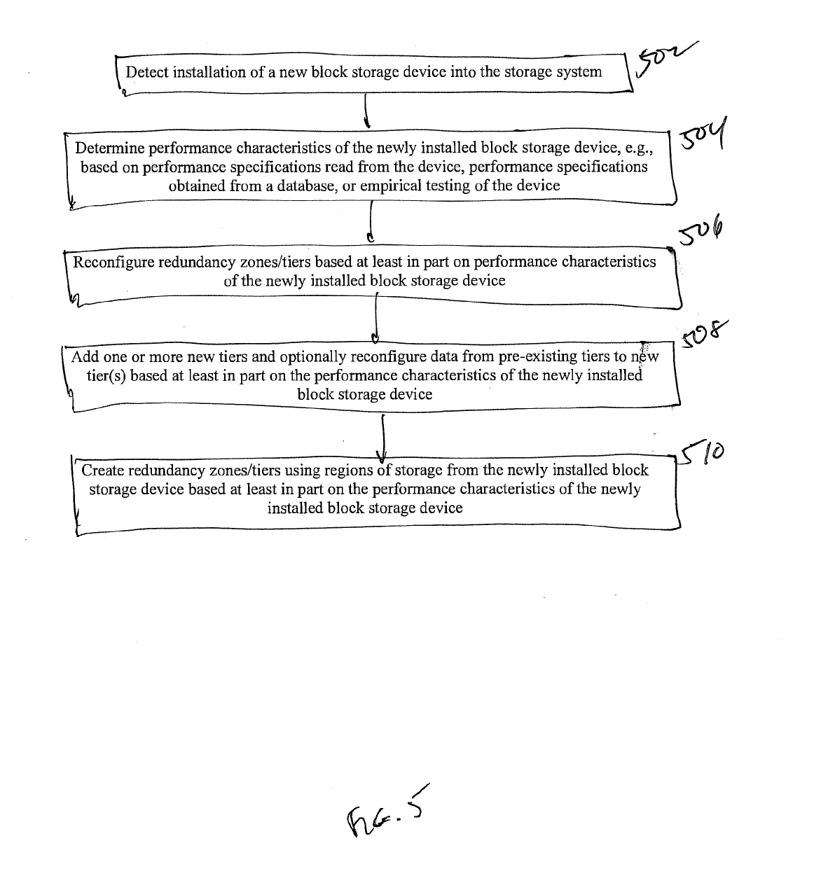

FIG. 5 schematically shows logic for managing block-level tiering when a block storage device is added to the storage system, in accordance with an exemplary embodiment. Upon detecting installation of a new block storage device (502), the storage controller determines performance characteristics of the newly installed block storage device, e.g., based on performance specifications read from the device, performance specifications obtained from a database, or empirical testing of the device (504) and then may take any of a variety of actions, including, but not limited to reconfiguring redundancy zones/tiers based at least in part on performance characteristics of the newly installed block storage device (506), adding one or more new tiers and optionally reconfigure data from pre-existing tiers to new tier(s) based at least in part on the performance characteristics of the newly installed block storage device (508), and creating redundancy zones/tiers using regions of storage from the newly installed block storage device based at least in part on the performance characteristics of the newly installed block storage device (510).

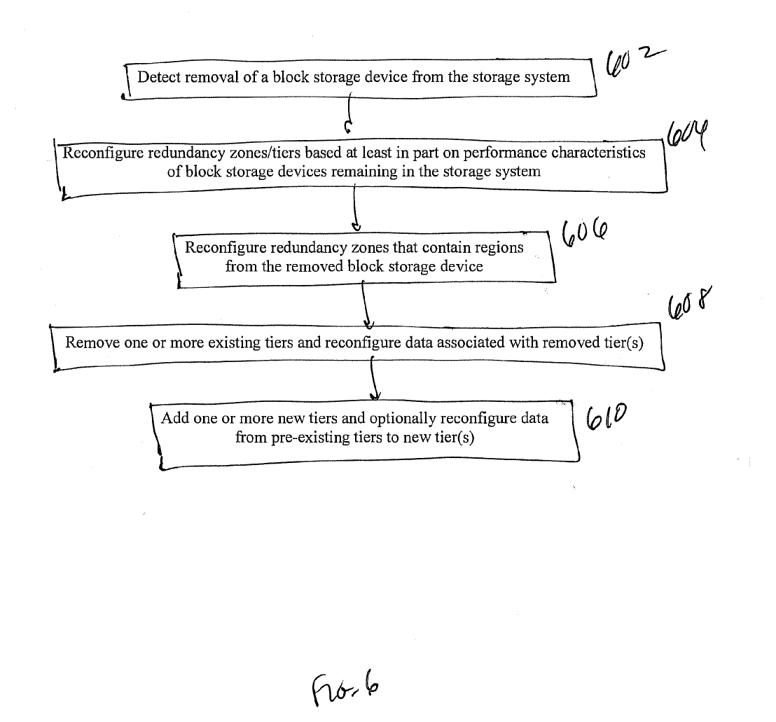

FIG. 6 schematically shows logic for managing block-level tiering when a block storage device is removed from the storage system, in accordance with an exemplary embodiment. Upon detecting removal of a block storage device (602), the storage controller may take any of a variety of actions, including, but not limited to reconfiguring redundancy zones/tiers based at least in part on performance characteristics of block storage devices remaining in the storage system (604), reconfiguring redundancy zones that contain regions from the removed block storage device (606), removing one or more existing tiers and reconfigure data associated with removed tier(s) (608), and adding one or more new tiers and optionally reconfigure data from pre-existing tiers to new tier(s) (610).

As mentioned above, the performance characteristics of certain block storage devices may change over time. For example, the effective performance of an HDD may degrade over time, e.g., due to changes in the physical storage medium, read/write head, electronics, etc. The storage controller may detect such changes in effective performance (e.g., through changes in read and/or write access times measured by the storage controller and/or through testing of the block storage device), and the storage controller may categorized or re-categorize storage from the degraded block storage device in view of the storage tiers being maintained by the storage controller.

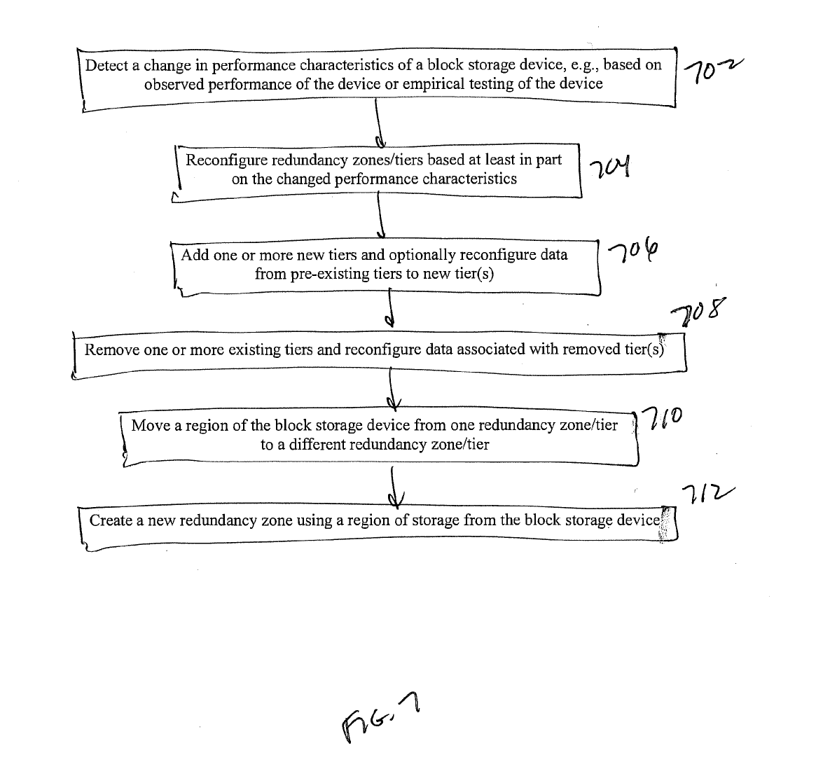

FIG. 7 schematically shows logic for managing block-level tiering based on changes in performance characteristics of a block storage device over time, in accordance with an exemplary embodiment. Upon detecting a change in performance characteristics of a block storage device (702), e.g., based on observed performance of the device or empirical testing of the device, the storage controller may take any of a variety of actions, including, but not limited to reconfiguring redundancy zones/tiers based at least in part on the changed performance characteristics (704), adding one or more new tiers and optionally reconfigure data from pre-existing tiers to new tier(s) (706), removing one or more existing tiers and reconfigure data associated with removed tier(s) (708), moving a region of the block storage device from one redundancy zone/tier to a different redundancy zone/tier (710), and creating a new redundancy zone using a region of storage from the block storage device (712).

For example, a region of storage from an otherwise high-performance block storage device (e.g., a SAS HDD) may be placed in, or moved to, a lower performance storage tier than it otherwise might have been placed, and if that degraded region is included in a zone, may reconfigure that zone to avoid the degraded region (e.g., replace the degraded region with a region from the same or different block storage device and rebuild the zone) or may move data from that zone to another zone. Furthermore, the storage controller may include the degraded region in a different zone/tier (e.g., a lower-level tier) in which the degraded performance is acceptable.

Similarly, the storage controller may determine that a particular region of a block storage device is not (or is no longer) usable, and if that unusable region is included in a zone, may reconfigure that zone to avoid the unusable region (e.g., replace the unusable region with a region from the same or different block storage device and rebuild the zone) or may move data from that zone to another zone.

Furthermore, the storage controller may be configured to incorporate block storage device performance characterization into its storage system condition indication logic. As discussed in U.S. Pat. No. 7,818,531 entitled Storage System Condition Indicator and Method, which is hereby incorporated herein by reference in its entirety, the storage controller may control one or more indicators to indicate various conditions of the overall storage system and/or of individual block storage devices. Typically, when the storage controller determines that additional storage is recommended, and all of the storage slots are populated with operational block storage devices, the storage controller recommends that the smallest capacity block storage device be replaced with a larger capacity block storage device. However, in various embodiments, the storage controller instead may recommend that a degraded block storage device be replaced even if the degraded block storage device is not the smallest capacity block storage device. In this regard, the storage controller generally must evaluate the overall condition of the system and the individual block storage devices and determine which storage device should be replaced, taking into account among other things the ability of the system to recover from removal/replacement of the block storage device indicated by the storage controller.

Regardless of whether storage tiers are defined statically or dynamically, the storage controller must determine an appropriate tier for various data, and particular for data stored on behalf of the host device both initially and over time (the storage controller may keep its own metadata, for example, in a high-speed tier).

When the storage controller receives a new block of data from the host device, the storage controller must select an initial tier in which to store the block. In this regard, the storage controller may designate a particular tier as a “default” tier and store the new block of data in the default tier, or the storage controller may store the new block of data in a tier selected based on other criteria, such as, for example, the tier associated with adjacent blocks or, in embodiments in which the storage controller implements filesystem-aware functionality as discussed above, perhaps based on information “mined” from the host filesystem data structures such as the data type.

In typical embodiments, the storage controller continues to make storage decisions on an ongoing basis and may reconfigure storage patterns from time to time based on various criteria, such as when a storage devices is added or removed, or when additional storage space is needed (in which case the storage controller may covert mirrored storage to striped storage to recover storage space). In the context of tiered storage, the storage controller also may move data between tiers based on a variety of criteria.

One way for the storage controller to determine the appropriate tier is to monitor access to blocks or ranges of blocks by the host device (e.g., number and/or type of accesses per unit of time), determine an appropriate tier for the data associated with each block or range of blocks, and reconfigure storage patterns accordingly. For example, a block or range of blocks that is accessed frequently by the host device may be moved to a higher-speed tier (which also may involve changing the redundant data storage pattern for the data, such as moving the data from a lower-speed striped tier to a higher-speed mirrored tier), while an infrequently accessed block or range of blocks may be moved to a lower-speed tier.

FIG. 8 schematically shows a logic flow for such block-level tiering, in accordance with an exemplary embodiment. Here, the storage controller in the block-level storage system monitors host accesses to blocks or ranges of blocks, in 802. The storage controller selects a storage tier for each block or range of blocks based on the host devices accesses, in 804. The storage controller establishes appropriate redundancy zones for the tiers of storage and stores each block or range of blocks in a redundancy zone associated with the tier selected for the block or range of blocks, in 806. As discussed herein, data can be moved from one tier to another tier from time to time based on any of a variety of criteria.

Unlike storage tiering at the filesystem level (e.g., where the host filesystem determines a storage tier for each block of data), such block-level tiering is performed independently of the host filesystem based on block-level activity and may result in different parts of a file stored in different tiers based on actual storage access patterns. It should be noted that this block-level tiering may be implemented in addition to, or in lieu of, filesystem-level tiering. Thus, for example, the host filesystem may interface with multiple storage systems of the types described herein, with different storage systems associated with different storage tiers that the filesystem uses to store blocks of data. But the storage controller within each such storage system may implement its own block-level tiering of the types described herein, arranging blocks of data (and typically providing redundancy for the blocks of data) in appropriate block-level tiers, e.g., based on accesses to the blocks by the host filesystem. In this way, the block-level storage system can manipulate storage performance even for a given filesystem-level tier of storage (e.g., even if the block-level storage system is considered by the host filesystem to be low-speed storage, the block-level storage system can still provide higher access speed to frequently accessed data by placing that data in a higher-performance block-level storage tier).

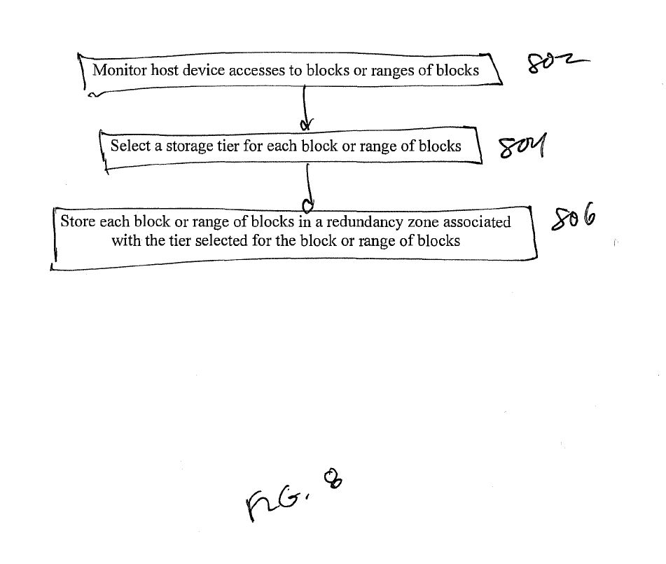

FIG. 9 schematically shows a block-level storage system (BLSS) used for a particular host filesystem storage tier (in this case, the host filesystem's tier 1 storage), in accordance with an exemplary embodiment. As discussed above, the storage controller in the BLSS creates logical block-level storage tiers for blocks of data provided by the host filesystem.

### Asymmetrical Redundancy

Asymmetrical redundancy is a way to use a non-uniform disk set to provide an “embedded tier” within a single RAID or RAID-like set. It is particularly applicable to RAID-like systems, such as the Drobo™ storage device, which can build multiple redundancy sets with storage devices of different types and sizes. Some examples of asymmetrical redundancy have been described above, for example, with regard to tiering (e.g., transaction-aware data tiering, physical and logical tiering, automatic tier generation, etc.) and hybrid HDD/SSD zones.

One exemplary embodiment of asymmetric redundancy, discussed under the heading Hybrid HDD/SSD Zones above, consists of mirroring data across a single mechanical drive and a single SSD. In normal operation, read transactions would be directed to the SSD, which can provide the data quickly. In the event that one of the drives fails, the data is still available on the other drive, and redundancy can be restored through re-layout of the data (e.g., by minoring affected data from the available drive to another drive). In this example, write transactions would be performance limited by the mechanical drive as all data written would need to go to both drives.

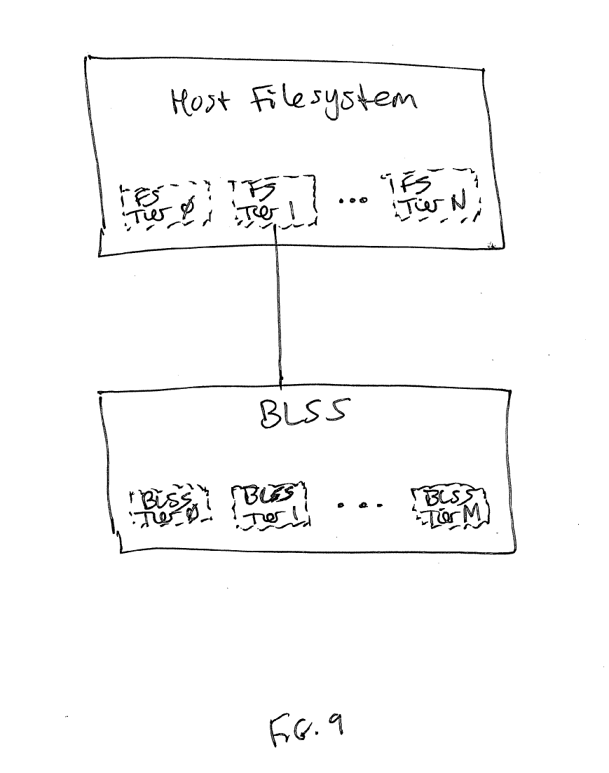

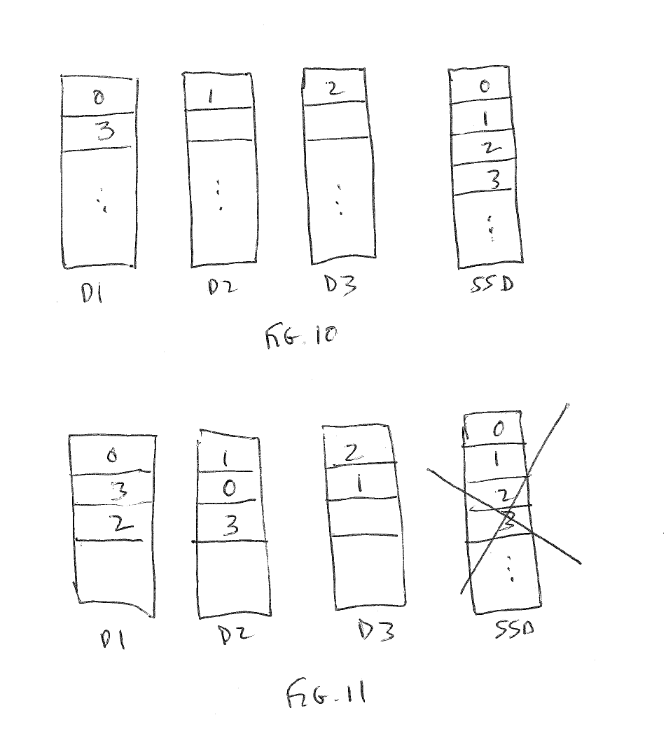

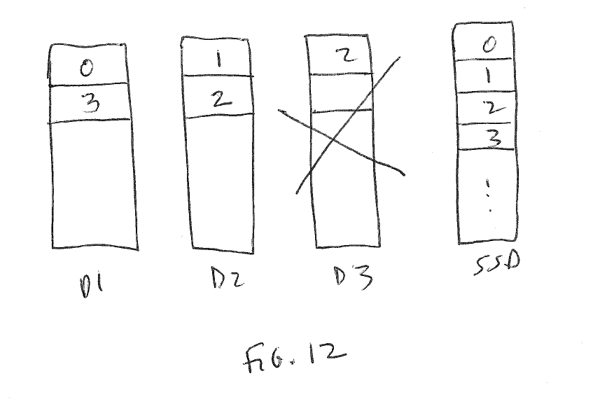

In other exemplary embodiments, multiple mechanical (disk) drives could be used to store data in parallel (e.g. a RAID 0-like striping scheme) with minoring of the data on the SSD, allowing write performance of the mechanical side to be more in line with the write speed of the SSD. For convenience, such a configuration may be referred to herein as a half-stripe-mirror (HSM). FIG. 10 shows an exemplary HSM configuration in which the data is RAID-0 striped across multiple disk drives (three, in this example) with minoring of the data on the SSD. In this example, if the SSD fails, data still can be recovered from the disk drives, although redundancy would need to be restored, for example, by minoring the data using the remaining disk drives as shown schematically in FIG. 11. If, on the other hand, one of the disk drives fails, then the affected data can be recovered from the SSD, although redundancy for the affected data would need to be restored, for example, by re-laying out the data in a striped pattern across the remaining disk drives, with minoring of the data still on the SSD as shown schematically in FIG. 12.

In other exemplary embodiments, the data on the mechanical drive set could be stored in a redundant fashion, with minoring on an SSD for performance enhancement. For example, the data on the mechanical drive set may be stored in a redundant fashion such as a RAID 1-like pattern, a RAID4/5/6-like pattern, a RAID 0+1 (mirrored stripe)-like fashion, a RAID 10 (striped mirror)-like fashion, or other redundant pattern. In these cases, the SSD might or might not be an essential part of the redundancy scheme, but would still provide performance benefits. Where the SSD is not an essential part of the redundancy scheme, removal/failure of the SSD (or even a change in utilization of the SSD as discussed below) generally would not require rebuilding of the data set because redundancy still would be provided for the data on the mechanical drives.

Furthermore, the SSD or a portion of the SSD may be used to dynamically store selected portions of data from various redundant zones maintained on the mechanical drives, such as portions of data that are being accessed frequently, particularly for read accesses. In this way, the SSD may be shared among various storage zones/tiers as form of temporary storage, with storage on the SSD dynamically adapted to provide performance enhancements without necessarily requiring re-layout of data from the mechanical drives.

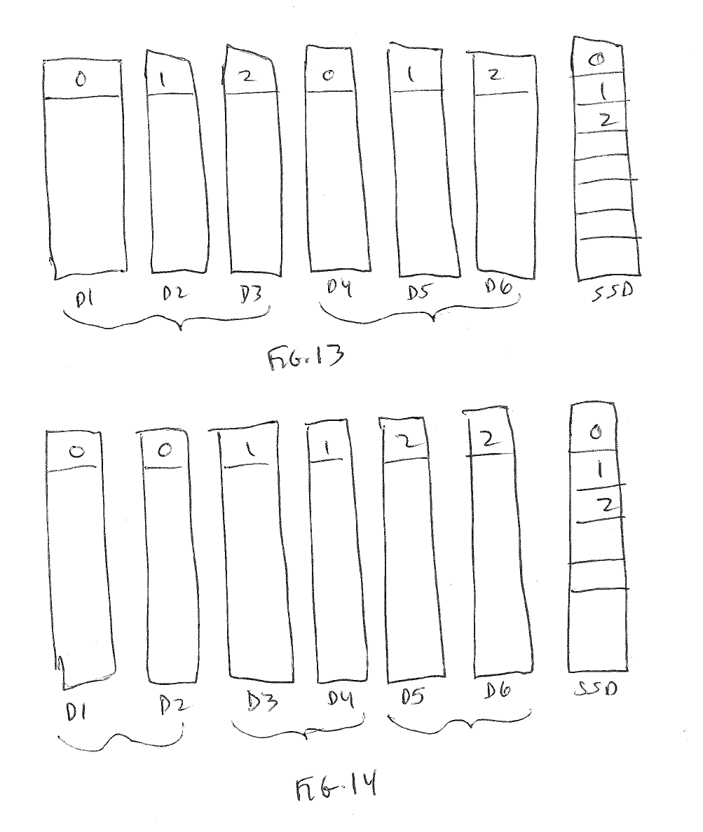

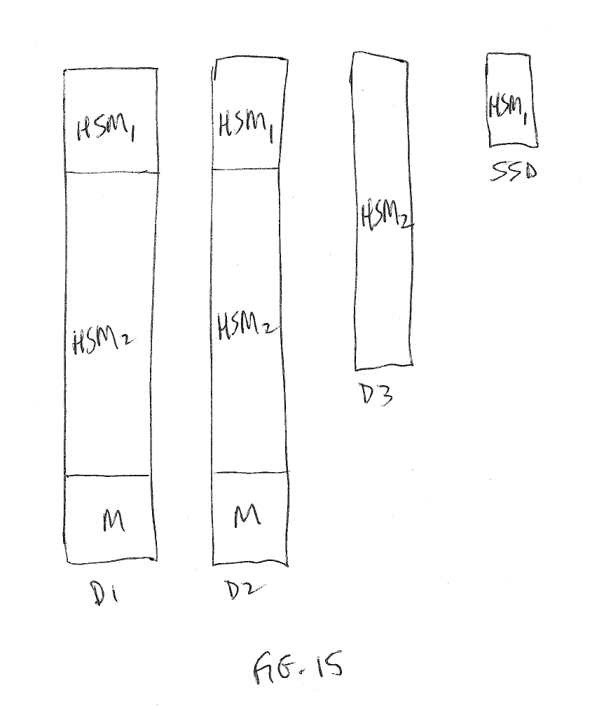

Additionally, in some cases, even though the SSD may not be an essential part of the redundancy scheme from the perspective of single drive redundancy (i.e., the loss or failure of a single drive of the set), the SSD may provide for dual drive redundancy, where data can be recovered from the loss of any two drives of the set. For example, a single SSD may be used in combination with mirrored stripe or striped mirror redundancy on the mechanical drives, as depicted in FIGS. 13 and 14, respectively.

In other exemplary embodiments, multiple mechanical drives and multiple

SSDs may be used. The SSDs could be used increase the size of the fast mirror. The fast mirror could be implemented with the SSDs in a JBOD (just a bunch of drives) configuration or in a RAID0-like configuration.

Asymmetrical redundancy is particularly useful in RAID-like systems, such as the Drobo™ storage device, which break the disk sets into multiple “mini-RAID sets” containing different numbers of drives and/or redundancy schemes. From a single group of drives, multiple performance tiers can be created with different performance characteristics for different applications. Any individual drive could appear in multiple tiers.

For example, an arrangement having 7 mechanical drives and 5 SSDs could be divided into tiers including a super-fast tier consisting of a redundant stripe across 5 SSDs, a fast tier consisting of 7 mechanical drives in a striped-mirror configuration mirrored with sections of the 5 SSDs, and a bulk tier consisting of the 7 mechanical drives in a RAID6 configuration. Of course, with 7 mechanical drives and 5 SSDs, a significant number of other tier configurations are possible based on the concepts described herein.

It should be clear that the addition of a single SSD to a set of mechanical drives can provide a significant boost to performance with only a minor addition to system cost. This is particularly true in systems, such as Drobo™ storage devices, that can assess the characteristics of different drives and build arbitrary redundant data groups with characteristics that are applicable to those data sets.

It should be noted that the concept of asymmetrical redundancy is not limited to the use of SSDs in combination with mechanical drives but instead can be applied generally to the creation of redundant storage zones from areas of storage having or configured to have different performance characteristics, whether from different types of storage devices (e.g., HDD/SSD, different types of HDDs, etc.) or portions of the same or similar types of storage devices. For example, a half-stripe-mirror zone may be created using two or more lower-performance disk drives in combination with a single higher-performance disk drive, where, for example, reads may be directed exclusively or predominantly to the high-performance disk drive. As but one example, FIG. 15 schematically shows a system having both SSD and non-SSD half-stripe-mirror zones. In this example, there are two large-capacity lower-performance disk drives D1 and D2, one higher-performance but lower-capacity disk drive D3, and an SSD, with three tiers of storage zones, specifically a high-performance tier HSM1 using portions of D1 and D2 along with the SSD, a medium-performance tier HSM2 using portions of D1 and D2 along with D3, and a low-performance tier using mirroring (M) across the remaining portions of D1 and D2. It should be noted that, typically, the zones would not be created sequentially in D1 and D2 as is depicted in FIG. 15. It also should be noted that the system could be configured with more or fewer tiers with different performance characteristics (e.g., zones with mirroring across D3 and SSD).

Thus, zones can be created using a variety of storage device types and/or storage patterns and can be associated with a variety of physical or logical storage tiers based on various storage policies that can take into account such things as the number and types of drives operating in the system at a given time (and the existing storage utilization in those drives, including the amount of storage used/available, the number of storage tiers, and the storage patterns), drive performance, data access patterns, and whether single drive or dual drive redundancy is desired for a particular tier, to name but a few.

### Other Embodiments

It should be noted that headings are used above for convenience and are not to be construed as limiting the present invention in any way.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions. Single-ended arrows generally indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

It should be noted that terms such as “client,” “server,” “switch,” and “node” may be used herein to describe devices that may be used in certain embodiments of the present invention and should not be construed to limit the present invention to any particular device type unless the context otherwise requires. Thus, a device may include, without limitation, a bridge, router, bridge-router (brouter), switch, node, server, computer, appliance, or other type of device. Such devices typically include one or more network interfaces for communicating over a communication network and a processor (e.g., a microprocessor with memory and other peripherals and/or application-specific hardware) configured accordingly to perform device functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages.

The source code may be in a computer executable form (e.g., via an interpreter), or the source code may be converted (e.g., via a translator, assembler, or compiler) into a computer executable form.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application.

Potential claims (prefaced with the letter “P” so as to avoid confusion with the actual claims presented below):

P1. A method of operating a data storage system having a plurality of storage media on which blocks of data having a pre-specified, fixed size may be stored, the method comprising: in an initialization phase, formatting the plurality of storage media to include a plurality of logical storage zones, wherein each logical storage zone is formatted to store data in a plurality of physical storage regions using a redundant data layout that is selected from a plurality of redundant data layouts, and wherein at least two of the storage zones have different redundant data layouts;

in an access phase, receiving a request to access a block of data in the data storage system for reading or writing;

classifying the access type as being either sequential access or random access;

selecting a storage zone to satisfy the request based on the classification; and

transmitting the request to the selected storage zone for fulfillment.

P2. The method of claim P1, wherein the storage media include both a hard disk drive and a solid state drive.

P3. The method of claim P1, wherein at least one logical storage zone includes a plurality of physical storage regions that are not all located on the same storage medium.

P4. The method of claim P3, wherein the at least one logical storage zone includes both a physical storage region located on a hard disk drive, and a physical storage region located on a solid state drive.

P5. The method of claim P1, wherein at least one physical storage region is a short-stroked portion of a hard disk drive.

P6. The method of claim P1, wherein the plurality of redundant data layouts includes a mirrored data layout and a striped data layout with parity.

P7. The method of claim P1, wherein classifying the access type is based on a logical address of a previous request.

P8. A computer program product comprising a tangible, computer usable medium on which is stored computer program code for executing the methods of any of claims P1-P7.

P9. A data storage system coupled to a host computer, the data storage system comprising:

a plurality of storage media;

a formatting module, coupled to the plurality of storage media, configured to format the plurality of storage media to include a plurality of logical storage zones, wherein each logical storage zone is formatted to store data in a plurality of physical storage regions using a redundant data layout that is selected from a plurality of redundant data layouts, and wherein at least two of the storage zones have different redundant data layouts;

a communications interface configured to receive, from the host computer, requests to access fixed-size blocks of data in the data storage system for reading or writing, and to transmit, to the host computer, data responsive to the requests;

a classification module, coupled to the communications interface, configured to classify access requests from the host computer as either sequential access requests or random access requests; and

a storage manager configured to select a storage zone to satisfy each request based on the classification and to transmit the request to the selected storage zone for fulfillment.

P10. A method for automatic tier generation in a block-level storage system, the method comprising:

determining performance characteristics of each of a plurality of block storage devices;

selecting regions of at least two block storage device, wherein the regions are selected for having complementary performance characteristics for a predetermined storage tier; and

creating a redundancy zone from the selected regions.

P11. A method according to claim P10, wherein determining performance characteristics of a block storage device comprises:

empirically testing performance of the block storage device.

P12. A method according to claim P11, wherein the performance of a block storage device is tested upon installation of the block storage device into the block-level storage system.

P13. A method according to claim P11, wherein the performance of each block storage device is tested at various times during operation of the block-level storage system.

P14. A method according to claim P11, wherein the regions are selected from at least two different types of block storage devices having different performance characteristics.

P15. A method according to claim P11, wherein the block storage devices from which the regions are selected are of the same block storage device type, and wherein each of the block storage devices from which the regions are selected includes a plurality of regions having different relative performance characteristics such that at least one region from each of the block storage devices is selected based on such relatively performance characteristics.

P16. A method for automatic tier generation in a block-level storage system, the method comprising:

configuring a first block storage device so that at least one region of the first block storage device has performance characteristics that are complementary to at least one region of a second block storage device according to a predetermined storage policy; and

creating a redundancy zone from at least one region of the first block storage device and at least one region of the second block storage device.

P17. A method for automatic tier generation in a block-level storage system, the method comprising:

detecting a change in performance characteristics of a block storage device; and

reconfiguring at least one redundancy zone/tier in the storage system based on the changed performance characteristics.

P18. A method according to claim P17, wherein reconfiguring comprises at least one of:

adding a new storage tier to the storage system;

removing an existing storage tier from the storage system;

moving a region of the block storage device from one redundancy zone/tier to another redundancy zone/tier; and
creating a new redundancy zone using a region of storage from the block storage device.

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A method of managing storage of blocks of data from a host computer in a block-level storage system having a storage controller in communication with a plurality of block storage devices, the method comprising:
automatically determining, by the storage controller, performance characteristics associated with at least one region of each block storage device; and
creating a plurality of redundancy zones from regions of the block storage devices, where at least one of the redundancy zones is a hybrid zone including at least two regions having different but complementary performance characteristics selected by the storage controller from different block storage devices based on a predetermined performance level selected for the zone by the storage controller.

2. A method according to claim 1, wherein the at least two regions are selected from regions having similar complementary performance characteristics.

3. A method according to claim 1, wherein the at least two regions are selected from regions having dissimilar complementary performance characteristics.

4. A method according to claim 1, wherein the at least two regions are selected from different types of block storage devices having different performance characteristics.

5. A method according to claim 4, wherein the at least two regions are selected from at least one solid state storage drive and from at least one disk storage device.

6. A method according to claim 1, wherein determining performance characteristics of a block storage device comprises at least one of:
determining the type of block storage device;
determining operating parameters of the block storage device; or
empirically testing performance of the block storage device.

7. A method according to claim 1, wherein the performance of a block storage device is tested upon installation of the block storage device into the block-level storage system.

8. A method according to claim 1, wherein the performance of a block storage device is tested at various times during operation of the block-level storage system.

9. A method according to claim 1, wherein the at least two regions are selected from the same types of block storage devices, such block storage devices including a plurality of regions having different relative performance characteristics, wherein at least one region is selected based on such relative performance characteristics.

10. A method according to claim 1, wherein the storage controller configures a selected block storage device so that at least one region of such block storage device selected for the hybrid zone has performance characteristics that are complementary to at least one region of another block storage device selected for the hybrid zone.

11. A method according to claim 1, wherein the redundancy zones are associated with a plurality of block-level storage tiers, wherein the storage controller automatically determines the types of storage tiers to have in the block-level storage system and automatically generates one or more zones for each of the tiers, wherein the predetermined storage policy selected for a given zone by the storage controller is based on the determination of the types of storage tiers.

12. A method according to claim 11, wherein the storage controller determines the types of storage tiers based on at least one of:
the types of host accesses to a particular block or blocks;
the frequency of host accesses to a particular block or blocks; or
the type of data contained within a particular block or blocks.

13. A method according to claim 1, further comprising:
detecting, by the storage controller, a change in performance characteristics of a block storage device; and
reconfiguring at least one redundancy zone in the block-level storage system based on the changed performance characteristics.

14. A method according to claim 13, wherein reconfiguring comprises at least one of:
adding a new storage tier to the storage system;
removing an existing storage tier from the storage system;
moving a region of the block storage device from one redundancy zone to another redundancy zone; or
creating a new redundancy zone using a region of storage from the block storage device.

15. A method according to claim 1, wherein each of the redundancy zones is configured to store data using a predetermined redundant data layout selected from a plurality of redundant data layouts, and wherein at least two of the zones have different redundant data layouts.

16. A block-level storage system comprising:
a storage controller for managing storage of blocks of data from a host computer; and
a plurality of block storage devices in communication with the storage controller, wherein the storage controller, wherein the storage controller is configured to automatically determine performance characteristics associated with at least one region of each block storage device and to create a plurality of redundancy zones from regions of the block storage devices, where at least one of the redundancy zones is a hybrid zone including at least two regions having different but complementary performance characteristics selected by the storage controller from different block storage devices based on a predetermined performance level selected for the zone by the storage controller.

17. A system according to claim 16, wherein the at least two regions are selected from regions having similar complementary performance characteristics.

18. A system according to claim 16, wherein the at least two regions are selected from regions having dissimilar complementary performance characteristics.

19. A system according to claim 16, wherein the at least two regions are selected from different types of block storage devices having different performance characteristics.

20. A system according to claim 19, wherein the at least two regions are selected from at least one solid state storage drive and from at least one disk storage device.

21. A system according to claim 16, wherein the storage controller determines performance characteristics of a block storage device by at least one of:
determining the type of block storage device;
determining operating parameters of the block storage device; or
empirically testing performance of the block storage device.

22. A system according to claim 16, wherein the storage controller tests performance of a block storage device upon installation of the block storage device into the block-level storage system.

23. A system according to claim 16, wherein the storage controller tests performance of a block storage device at various times during operation of the block-level storage system.

24. A system according to claim 16, wherein the storage controller selects at least two regions from the same types of block storage devices, such block storage devices including a plurality of regions having different relative performance characteristics, and wherein the storage controller selects at least one region based on such relative performance characteristics.

25. A system according to claim 16, wherein the storage controller configures a selected block storage device so that at least one region of such block storage device selected for the hybrid zone has performance characteristics that are complementary to at least one region of another block storage device selected for the hybrid zone.

26. A system according to claim 16, wherein the redundancy zones are associated with a plurality of block-level storage tiers, wherein the storage controller automatically determines the types of storage tiers to have in the block-level storage system and automatically generates one or more zones for each of the tiers, wherein the predetermined storage policy selected for a given zone by the storage controller is based on the determination of the types of storage tiers.

27. A system according to claim 26, wherein the storage controller determines the types of storage tiers based on at least one of:
the types of host accesses to a particular block or blocks;
the frequency of host accesses to a particular block or blocks; or
the type of data contained within a particular block or blocks.

28. A system according to claim 16, wherein the storage controller is further configured to detect a change in performance characteristics of a block storage device and reconfigure at least one redundancy zone in the block-level storage system based on the changed performance characteristics.

29. A system according to claim 28, wherein reconfiguring comprises at least one of:
adding a new storage tier to the storage system;
removing an existing storage tier from the storage system;
moving a region of the block storage device from one redundancy zone to another redundancy zone; or
creating a new redundancy zone using a region of storage from the block storage device.

30. A system according to claim 16, wherein each of the redundancy zones is configured to store data using a predetermined redundant data layout selected from a plurality of redundant data layouts, and wherein at least two of the zones have different redundant data layouts.
